(19) United States
(12) Patent Application Publication
(10) Pub. No.: US 2026/0081480 A1
(43) Pub. Date: Mar. 19, 2026

(54) RECEIVER, ELECTRONIC CIRCUIT, AND METHOD FOR DETERMINING POWER RECEIVING STATE

(71) Applicant: AETERLINK CORP., Tokyo (JP)

(72) Inventors: Shingo TAKEUCHI, Tokyo (JP); Shingo HIKOSAKA, Tokyo (JP); Naoto KODATE, Tokyo (JP)

(21) Appl. No.: 19/396,589

(22) Filed: Nov. 21, 2025

Related U.S. Application Data
(63) Continuation-in-part of application No. PCT/JP2024/018090, filed on May 16, 2024.

(30) Foreign Application Priority Data
May 23, 2023 (JP) 2023-084455

(51) Int. Cl. H02J 50/80; H02J 50/20; H02J 50/40

(52) U.S. Cl. CPC H02J 50/80; H02J 50/20; H02J 50/40

(57) ABSTRACT

A receiver is provided for wirelessly receiving microwave power. The receiver includes a rectifier that rectifies the transmitting power, an electric power management device that manages a rectified voltage from the rectifier, a charger that is charged by an output voltage from the power management device, and a controller that controls these components. The controller includes a first control module that controls transmission and reception of signals between the controller and an external device, a second control module that detects a predetermined voltage value in the receiver and stores the detected voltage value in a temporary storage area, and a third control module that determines a power receiving state of the receiver based on the voltage value stored in the temporary storage area.

### CROSS-REFERENCE TO RELATED APPLICATIONS

This application is a Continuation-in-Part of International Application No. PCT/JP2024/018090, filed on May 16, 2024, which claims the benefit of priority to Japanese Patent Application No. 2023-084455, filed on May 23, 2023, the contents of which are incorporated herein by reference.

### FIELD OF THE INVENTION

The present disclosure relates to a receiver, an electronic circuit, and a method for determining a power receiving state.

### BACKGROUND

In wireless power feeding systems, there is a technique to charge a secondary battery of a receiver by wirelessly transmitting electric power thereto, and to carry out a control such that when a rectified output voltage at the time of wirelessly feeding power is equal to or more than a predetermined value, a constant voltage generation part which supplies a power supply voltage to a sensor device is fed with electric power by wirelessly feeding power thereto, and that when the rectified output voltage is less than the predetermined value, the constant voltage generation part is fed with electric power from the secondary battery (Patent Document 1).

### PRIOR ART DOCUMENTS

[Patent Document 1] Japanese Patent Application Publication No. 2019-004611

### SUMMARY OF THE INVENTION

### [Problem to be solved by the invention]

When power is fed wirelessly, the power feeding state is influenced by the environment, and as a result, it is difficult to stably supply a fixed amount of electric power, and there is a possibility that the amount of power to be fed is fluctuated greatly over time. However, in the technique disclosed in the Patent Document 1, the power feeding state of the receiver, in other words, the power receiving state of the receiver is not determined. On the other hand, when a CPU mounted on a microcomputer in the receiver carries out the determination process of the power receiving state of the receiver, there is a concern that power is consumed in the determination process.

An object of the present disclosure is to provide a technique for determining a power receiving state of a receiver when power is fed wirelessly to the receiver, while enabling power-saving.

### [Means for solving the problem]

The present disclosure provides a receiver for wirelessly receiving microwave power. The receiver includes a rectifier that rectifies the transmitting power, an electric power management device that manages a rectified voltage from the rectifier, a charger that is charged by an output voltage from the electric power management device, and a controller configured to control these components. The controller includes a first control module configured to control transmission and reception of signals between the controller and an external device, a second control module configured to detect a predetermined voltage value in the receiver and store the detected voltage value in a temporary storage area, and a third control module configured to determine a power receiving state of the receiver based on the voltage value stored in the temporary storage area.

### [Effect of the Invention]

According to the present disclosure, it is possible to provide a technique for determining a power receiving state of a receiver when power is fed wirelessly to the receiver, while enabling power-saving.

### BRIEF DESCRIPTION OF THE DRAWINGS

FIG. 1 is a diagram illustrating an entire configuration of a wireless power feeding system (or WPT system: wireless power transfer system) according to a first embodiment.

FIG. 2 is a block diagram illustrating a configuration example of a transmitter and a receiver illustrated in FIG. 1.

FIG. 3 is a diagram illustrating an outline of a circuit configuration of the receiver according to the first embodiment.

FIG. 4 is a diagram illustrating a functional configuration of a microcomputer of the receiver according to the first embodiment.

FIG. 5 is a diagram for explaining a configuration and processing of a voltage acquiring part in a microcomputer of the receiver according to the first embodiment.

FIG. 6 is a diagram illustrating an example of a data structure of a determination table according to the first embodiment.

FIG. 7 is a flowchart illustrating an example of a processing flow in the receiver according to the first embodiment.

FIG. 8 is a diagram illustrating a functional configuration of a microcomputer of a receiver according to a second embodiment.

FIG. 9 is a diagram for explaining a configuration of a power receiving state determination part in the microcomputer of the a receiver according to the second embodiment.

FIG. 10 is a diagram for explaining a configuration and processing of a gradient calculation part and a gradient comparison part in the power receiving state determination part.

FIG. 11 is a diagram illustrating one example of a data structure of a determination table according to the second embodiment.

FIG. 12 is a diagram for explaining a configuration and processing of a power supply voltage comparing part in the power receiving state determination part.

FIG. 13 a diagram illustrating one example of a data structure of a determination table according to the second embodiment.

FIG. 14 is a diagram for explaining a configuration and processing of a rectified voltage comparing part in the power receiving state determination part.

FIG. 15 is a diagram illustrating one example of a data structure of a determination table according to the second embodiment.

FIG. 16 is a diagram for explaining the configuration and processing of a determination part in the power receiving state determination part.

FIG. 17 is a diagram illustrating one example of a data structure of a determination table according to the second embodiment.

### DESCRIPTION OF THE PREFERRED EMBODIMENTS

Hereinafter, the present embodiments will be explained with referring to the figures. In all the figures describing the embodiments, the same reference signs are attached to the common configuration elements, and the duplicated explanations are omitted for those configuration elements. The following embodiments are provided for the purpose of not unreasonably limiting the present disclosure described in the claims. Also, not all of the configuration elements described in the embodiments are always necessary in the present disclosure. Further, the figures are schemas, and are not always strictly illustrated.

In the following descriptions, a "processor" shall mean one or more processors. Typically, the at least one processor is a microprocessor such as a CPU (or Central Processing Unit), but other types of processor such as a GPU (or Graphics Processing Unit) can also be used for the processor. The at least one processor may be a single-core processor or a multi-core processor.

In addition, the at least one processor may be a processor in a broad sense, such as a hardware circuit capable of performing some or all of processes, for example, the hardware circuit may be a FPGA (or Field-Programmable Gate Array) or an ASIC (or Application Specific Integrated Circuit).

Further, in the following explanations, an expression such as a "*** table" may be used to give an explanation for information with which an output is obtained with respect to an input. This information may be data having an arbitrary structure, or it may be a learning model such as a neural network capable of generating an output with respect to an input. Therefore, it is possible to paraphrased a "*** table " to "*** information".

Further, in the following descriptions, a configuration of each table is given as one example. One table may be divided into two or more tables. Also, some or all of two or more tables may be integrated into one piece.

Further, in the following descriptions, a "program" can be expressed as a subject to carry out the processing. However, it is also possible to express a “processor (or a device such as a controller having the processor)” as the subject to carry out the processes. Because, when a processor executes a program, the program carries out predetermined processes by appropriately using a storage part (or memory) and/or an interface part. In the present disclosure, the controller of the receiver may be implemented as a plurality of functional control modules. For example, the controller may include a first control module, a second control module, and a third control module. Each of these control modules corresponds to a functional block in the embodiments described below. Specifically, the first control module may be implemented by a reception control module configured to control transmission and reception of signals between the controller and an external device. The second control module may be implemented by a module corresponding to the voltage acquiring part or a function thereof, such as a module configured to detect a predetermined voltage value in the receiver and to store the detected voltage value in a temporary storage area. The third control module may be implemented by a functional module configured to determine a power receiving state of the receiver based on the voltage value stored in the temporary storage area. Furthermore, the first to third control modules may be realized either by a processor executing software or by dedicated hardware circuits, or by any combination thereof.

The program may be installed in a device such as a computer, or may be provided in a program distribution server or a computer readable medium (for example, a non-transitory computer readable medium). In the following descriptions, two or more programs may be implemented as one program. Alternatively, one program may be implemented as two or more programs.

Further, in the following descriptions, identification numbers are used as identification information for indicating various objects. However, it is possible to use identification information (for example, identifiers having alphabetic characters and/or codes) different from the identification numbers.

Further, in the following descriptions, reference signs (or common reference signs in a group of the reference signs) may be used to give an explanation for configuration elements having the same or similar kind when these configuration elements are not distinguished from each other. Also, identification numbers (or reference signs) may be used to give an explanation for configuration elements having the same or similar kind when these configuration elements are distinguished from each other.

Further, in the following descriptions, control lines and information lines which are considered to be necessary to give an explanation are illustrated, but all the control lines and information lines of the product are not necessarily illustrated. Also, all configurations may be made to be connected with each other.

### <0 System Overview>

A WPT system according to the present disclosure includes a receiver which is capable of receiving electric power (or power) transmitted from a transmitter, and is capable of feeding electric power to a device, based on a wireless power feeding system or wireless power transfer system (WPT).

Hereinafter, in the following first embodiment, the details are described. In the WPT system according to the present disclosure, an antenna of a receiver receives microwave power (or a substantially continuous wave (CW) of a sine wave having 920MHz), and then a rectifier circuit functionally connected to the antenna converts the radio wave into a DC voltage. And an electric power management part controls the DC voltage outputted from the rectifier circuit and supplies the voltage to a charger (which is mainly a capacitor).

A power storage element(s) constituting the charger is not particularly limited, and for example, it may be a capacitor, a lithium-ion battery, an electrical double-layer capacitor, a ceramic capacitor, or the like. In the WPT system according to the present disclosure, it is explained that the charger mainly includes a capacitor(s).

A voltage fed from the electric power management part is supplied to the charger when a voltage stored in the charger is less than a predetermined value. When the charger is charged to a predetermined voltage, electric power fed from the electric power management part is supplied to a microcomputer.

When electric power is fed wirelessly, the power feeding state can be influenced by the environment, and accordingly, it is difficult to stably feed a constant amount of power, and also the amount of electric power to be fed greatly fluctuates with time. Similarly, even in another type of wireless power feeding system based on a solar cell or a laser system, the amount of electric power to be fed may be fluctuated. In such situations where the power feeding state is not stable, it is necessary to diagnose whether feeding power can be continued in order to stably feed power to a microcomputer of the receiver and further to a sensor device which is included in the receiver, on each occasion.

If the result of the diagnosis is not preferable, it is necessary to notify the transmitter and/or the information processing device that monitors the transmitter and the receiver in the WPT system, and in some cases, it is required to normally finish the system. The diagnosis is performed at a stage where the transmitter and/or the receiver is/are installed and at both of a stage when the operation is actually performed and a stage when the maintenance is performed.

However, as described above, the amount of electric power to be fed to the receiver can greatly fluctuate with time, and accordingly, the power receiving state of the receiver may not be precisely determined by instantaneously checking the voltage value in the receiver. For example, even when the power supply voltage which is the charging voltage of the charger has a normal voltage value, when the rectified voltage which is the output value from the rectifier circuit has a voltage value close to zero, electric power cannot be stably fed to the receiver, and therefore, there is a possibility that feeding electric power to a device may eventually be interrupted.

Therefore, it is conceivable that the receiver is configured to acquire two voltage values of the power supply voltage and of the rectified voltage and to transmit the data to the transmitter and/or the information processing device. However, in such a case, it is required to frequently transmit the data, and accordingly, the power consumption in the receiver will be increased. Furthermore, in a case that one transmitter is associated with several tens or close to a hundred receivers, the computational load of the transmitter (including the information processing device) will be increased.

Therefore, in the WPT system according to the present disclosure, the power supply voltage and the rectified voltage of the receiver are respectively made to be compared with the threshold value to determine whether the receiver is capable of maintaining the function of feeding power to the microcomputer or the like.

It should be understood that the specific configurations of the WPT system according to the present disclosure are not limited to the configurations which have been described above.

### <1. First Embodiment>

### <1.1 Entire Configuration of System>

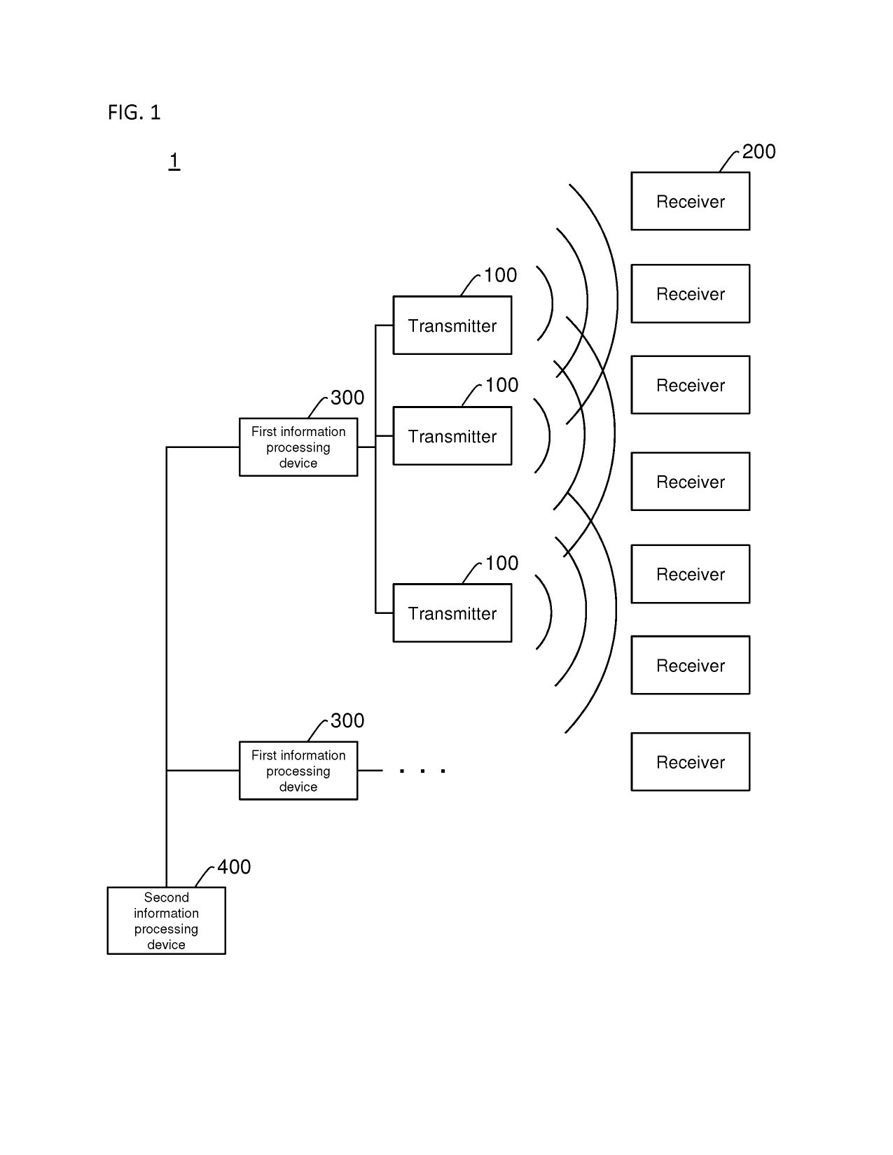

FIG. 1 shows a diagram giving an explanation of an entire configuration of a wireless power feeding system or wireless power transfer system (WPT system) according to a first embodiment.

The WPT system 1 illustrated in FIG. 1 includes, for example, a transmitter(s) 100, a receiver(s) 200, a first information processing device(s) 300, and a second information processing device(s) 400. For example, the WPT system 1 illustrated in FIG. 1 is capable of being used in a building, a factory or the like.

In the present specification, the transmitter 100 means a transmitting device (or electric power transmitting device) 100 capable of wirelessly transmitting electric power. Similarly, the receiver 200 means a receiving device (or electric power receiving device) 200 capable of wirelessly receiving electric power. As described below, the transmitter 100 may be configured to transmit information, for example, information relating to a state(s) of the receiver 200 or information relating to a measurement result(s) of a sensors, to the transmitter 100, as a data signal(s), and the transmitter 100 may be configured to receive such a data signal. In such a case, the transmitter 100 functions as a receiver capable of receiving a data signal, and the receiver 200 functions as a transmitter capable of transmitting a data signal.

In FIG. 1, it is illustrated that three pieces of transmitters 100 are included in the WPT system 1, but the number of the transmitters 100 included in the WPT system 1 is not limited to three. The number of the transmitters 100 included in the WPT system 1 may be two or less, or may be four or more.

In FIG. 1, it is illustrated that seven pieces of receivers 200 are included in the WPT system 1, but the number of the receivers 200 included in the WPT system 1 is not limited to seven. The number of the receivers 200 included in the WPT system 1 may be six or less, or may be eight or more.

In FIG. 1, it is illustrated that two pieces of first information processing device 300 are included in the WPT system 1, but the number of the first information processing device 300 included in the WPT system 1 is not limited to two. The number of the first information processing device 300 included in the WPT system 1 may be one, or may be three or more.

For example, the transmitter 100 transmits a power feeding signal(s) or a data signal(s) to the receiver 200. For example, the transmitter 100 transmits a power feeding signal to the receiver 200 by a radio wave(s) in a 920MHz band. For example, the transmitter 100 transmits a data signal to the receiver 200 by a radio wave(s) in a 2.4GHz band. The transmitter 100 may also transmit a data signal by a radio wave in a 920MHz band. In the present disclosure, the transmitting power wirelessly supplied to the receiver may be any microwave power, including but not limited to radio waves in the 920 MHz band described above. The microwave power may be a continuous wave, a substantially continuous wave having a pause period prescribed by radio regulations, or any other microwave signal capable of supplying power to the receiver. The frequency of the microwave power is therefore not limited to a specific value, and may include frequencies of 0.9 GHz or higher, or other frequencies suitable for wireless power feeding depending on the installation environment and system requirements.

In one example, the transmission signal to be transmitted from the transmitter 100 may be a continuous wave (CW) of a sine wave having predetermined electric power. In addition, the frequency band of the power feeding signal is, for example, a 920MHz band, considering the distance between the transmitter 100 and the receiver 200. If the frequency band is higher than the exemplified frequency band, there is a possibility that predetermined operable power may not be fed to the receiver 200, unless the distance between the transmitter 100 and the receiver 200 is shortened. Therefore, an appropriate frequency band can be determined by taking into consideration a practical range (for example, the distance between the transmitter 100 and the receiver 200 is made to be several meters).

In some cases, a restriction may be imposed to intermittently transmit power feeding signals having predetermined electric power, by the legislation of a country where the WPT system 1 is installed. In one example, when power feeding signals transmitted from the transmitter 100 fall under the provisions of radio stations prescribed in the Radio Act of Japan, it may be necessary to provide a pause period for temporarily stopping transmitting the power feeding signals (regardless of qualifications). In this case, considering a certain degree of continuity on a time axis, it cannot be said that the power feeding signals are continuous waves. However, though it is required to provide a pause period, this time period can be a very little time, and thus it is still possible to regard the power feeding signals to be transmitted from the transmitter 100 as continuous waves.

For example, the transmitter 100 may feed electric power to one receiver 200 or to a plurality of receivers 200. Also, for example, the transmitter 100 may transmit data signals to one receiver 200 or may transmit data signals to a plurality of receivers 200. In addition, the transmitter 100 may transmit data signals which are the same as those of the other transmitter(s) 100. Alternatively, the transmitter 100 may transmit data signals which are different from those of the other transmitter(s) 100. Further, for example, the transmitter 100 may transmit predetermined command signals, as the data signals, to the receiver 200, or may transmit preset signals, as the data signals, to the receiver 200.

For example, the transmitter 100 receives data signals transmitted from the receiver 200. Also, for example, the transmitter 100 may receive data signals transmitted from one receiver 200 or may receive data signals transmitted from a plurality of receivers 200. In addition, the transmitter 100 transmits the data signals transmitted from the receiver 200 to the first information processing device 300. Also, the transmitter 100 transmits information relating to the state of the transmitter 100 to the first information processing device 300.

For example, the receiver 200 receives power feeding signal(s) or data signal(s), transmitted from the transmitter 100. For example, when the receiver 200 is provided with a charger, the receiver 200 converts power feeding signals transmitted from the transmitter 100 into electric power, and stores the converted power in the charger. For example, when the receiver 200 is provided with a certain sensor, the receiver 200 converts power feeding signals transmitted from the transmitter 100 into electric power, and drives the sensor by the converted power.

For example, the receiver 200 transmits information relating to the state of the receiver 200 or information relating to the measurement result of the sensor, to the transmitter 100, as the data signal.

The first information processing device 300 is configured to monitor the operations of the transmitter 100 and of the receiver 200, each of which is included in the WPT system 1. For example, the first information processing device 300 determines whether the transmitter 100 or the receiver 200 is in a predetermined state, based on the information, transmitted from the transmitter 100, which is relating to the state of the transmitter 100 and that of the receiver 200. When it is determined that the state is in a predetermined state, the first information processing device 300 transmits predetermined information to the second information processing device 400.

In addition, the first information processing device 300 accumulates information relating to the transmitter 100 and the receiver 200, each of which is included in the WPT system 1. For example, the first information processing device 300 stores information, transmitted from the transmitter 100, which is relating to the state of the transmitter 100 and that of the receiver 200, in a storage part (or memory) provided in the first information processing device 300.

In addition, the first information processing device 300 is configured to control the operation of the transmitter 100 which is included in the WPT system 1.

The second information processing device 400 is configured to be operated by an administrator of the WPT system 1. When the second information processing device 400 receives, from the first information processing device 300, a notification indicating that the transmitter 100, the receiver 200, or both of them which are included in the WPT system 1 are in a predetermined state, the second information processing device 400 notifies the user that the transmitter 100, the receiver 200, or both of them are in the predetermined state.

In addition, the second information processing device 400 analyzes the information, stored in the first information processing device 300, which is relating to the state of the transmitter 100 and that of the receiver 200 and notifies the user the predetermined information. The predetermined information is, for example, as follows:

Information relating to the arrangement of the transmitter(s) 100,

Information relating to the arrangement of the receiver(s) 200,

Information relating to the power consumption,

Information relating to the power intensity.

### <1.2 Configurations of Transmitter and Receiver>

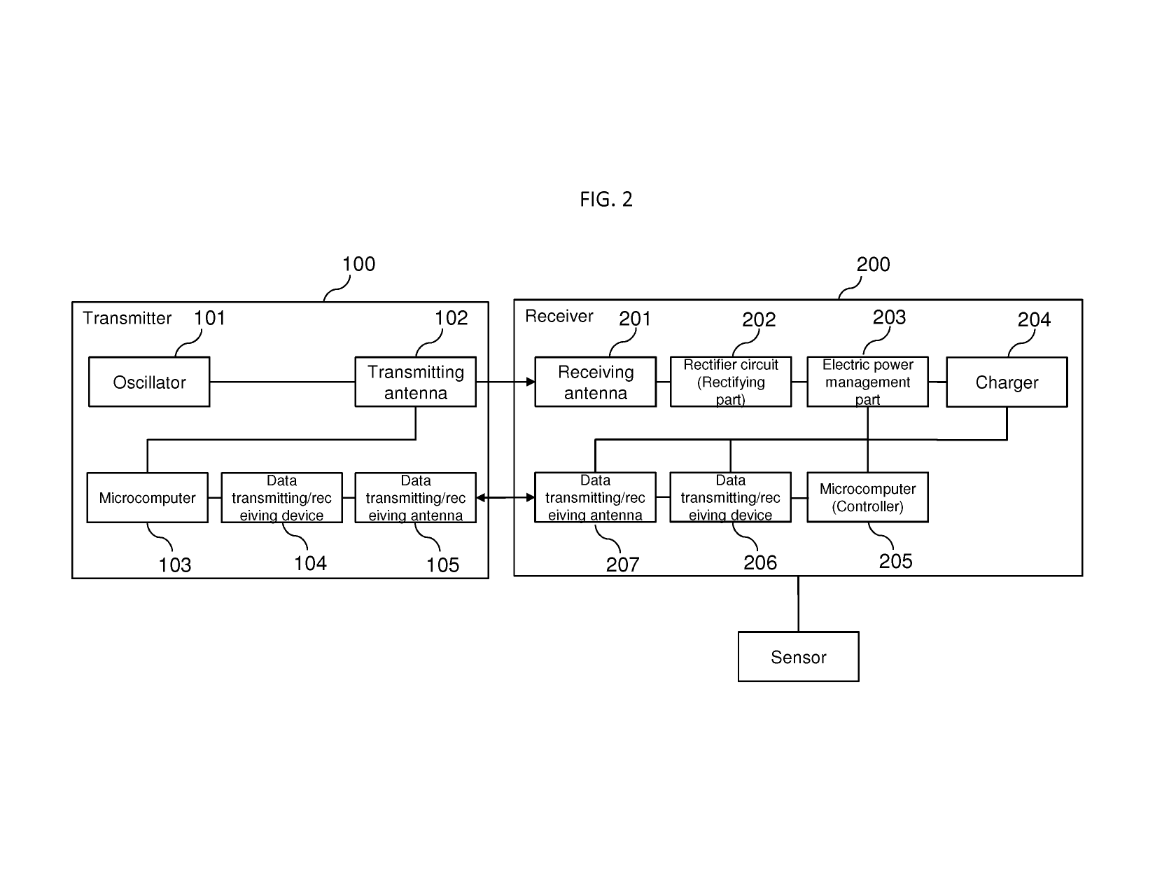

FIG. 2 shows a block diagram illustrating a configuration example of a transmitter 100 and that of a receiver 200 both of which are illustrated in FIG. 1.

As illustrated in FIG. 2, the transmitter 100 and the receiver 200 are, for example, spaced apart from each other by a predetermined interval. For example, the transmitter 100 and the receiver 200 are separated from each other by a distance of about several meters. Specifically, for example, the transmitter 100 is fixedly installed at a high place in a building (for example, at a predetermined high position on a ceiling or a wall). The receiver 200 may be installed in a predetermined device in a building or placed in the vicinity of a device which is required to be fed with power. Also, the receiver 200 may be configured to be carried by a user. The transmitter 100 transmits power feeding signals to the receiver 200 by radio waves of a predetermined frequency, for example, in a 920MHz band. The receiver 200 converts the power feeding signals transmitted from the transmitter 100 into electric power, and then charges the converted power or supplies the converted power to a predetermined device.

For example, the transmitter 100 is provided with an oscillator 101, a transmitting antenna 102, a microcomputer 103, a data transmitting/receiving device 104, and a data transmitting/receiving antenna 105. In one example, the oscillator 101, the microcomputer 103, and the data transmitting/receiving device 104 may be mounted on a PCB (or printed circuit board).

The oscillator 101 is configured to oscillate signals in a predetermined frequency band(s), for example, in a 920MHz band. The oscillated signals may be amplified, according to the need, to remove unnecessary frequency components.

For example, the transmitting antenna 102 is configured to be capable of efficiently transmitting radio waves in a 920MHz band. The transmitting antenna 102 radiates the signals which have been oscillated by the oscillator 101, as power feeding signals.

The microcomputer 103 is configured to control the operations of the transmitter 100. For example, the microcomputer 103 is realized by a semiconductor device equipped with an ARM processor. For example, the microcomputer 103 controls the transmission of radio waves to be emitted from the transmitting antenna 102.

For example, when the WPT system 1 is used in a factory, it is desirable that the receiver 200 feeds power of a predetermined value or more. Therefore, the microcomputer 103 controls the transmission of radio waves to be emitted from the transmitting antenna 102, based on feedback signals transmitted from the receiver 200. For example, the feedback signals relate to voltage values of a predetermined part in the receiver 200. By using the feedback signal, it becomes possible to simulatively perceive the electric field strength of the receiver 200. In a case when the transmitting antenna 102 includes, for example, a plurality of antenna elements, the microcomputer 103 controls the transmitting antenna 102 so as to transmit power feeding signals from an antenna element which is determined to be optimum. For example, the microcomputer 103 adjusts the polarization direction of the power feeding signal by switching the antenna element(s) to be driven. Further, the microcomputer 103 adjusts the directivity of the power feeding signal by adjusting the driving timing of the antenna element(s).

In addition, when the WPT system 1 is used in a building such as a room, the microcomputer 103 controls the transmission of radio waves to be emitted from the transmitting antenna 102, based on the feedback signals transmitted from the receiver 200. In a case when the transmitting antenna 102 is a single antenna element, the microcomputer 103 optimizes the transmission power emitted from the transmitting antenna 102.

The data transmitting/receiving device 104 is configured to perform processes such as a process for converting the digital data into an analog signal(s) and a process for modulating the analog data. Further, the data transmitting/receiving device 104 performs processes such as a process for demodulating signals extracted from data signals that are received by the data transmitting/receiving antenna 105, and a process for digitizing the demodulated analog data. For example, the data transmitting/receiving device 104 extracts feedback signals from the data signals received by the data transmitting/receiving antenna 105, converts the feedback signals into digital data and transmits the digital data to the microcomputer 103.

For example, the data transmitting/receiving antenna 105 is configured to be capable of efficiently transmitting and receiving radio waves in a 2.4GHz band. The data transmitting/receiving antenna 105 emits the data signals supplied from the data transmitting/receiving device 104. Further, the data transmitting/receiving antenna 105 receives the data signals transmitted from the receiver 200.

For example, the receiver 200 is provided with a receiving antenna 201, a rectifier circuit (or rectification part) 202, an electric power management part (or power manager) 203, a charger (or charging part) 204, a microcomputer (or controller) 205, a data transmitting/receiving device 206, and a data transmitting/receiving antenna 207. For example, the rectifier circuit 202, the electric power management part 203, the charger 204, the microcomputer 205, and the data transmitting/receiving device 206 may be mounted on a PCB or a FPC (or flexible board).

For example, the receiving antenna 201 is configured to be capable of efficiently receiving radio waves in a 920MHz band. The receiving antenna 201 receives power feeding signals emitted from the transmitting antenna 102.

The rectifier circuit 202 is configured to rectify radio waves received as power feeding signals and then converts them into DC voltage.

The electric power management part 203 is configured to manage the DC voltage. For example, the electric power management part 203 controls the charging voltage based on the DC voltage. The electric power management part 203 charges the charger 204 by controlling the charging voltage. In addition, for example, when a predetermined capacity or more of electric power is stored in the charger 204, the electric power management part 203 supplies the DC voltage to an arbitrary member which is connected thereto.

In addition, the electric power management part 203 releases electric power accumulated in the charger 204 in accordance with a control from the microcomputer 205.

The charger 204 accumulates electric power in response to an instruction from the electric power management part 203. In addition, the charger 204 releases the accumulated electric power in response to an instruction from the electric power management part 203.

The microcomputer 205 (hereinafter, which is referred to as a microcontroller or controller as appropriate) is configured to control the operations of the receiver 200. The microcomputer 205 is driven by a DC voltage supplied from the electric power management part 203 or by electric power which has been accumulated in the charger 204. The microcomputer 205 controls the electric power management part 203 to release electric power accumulated in the charger 204.

The receiver 200 may be connected with a sensor of an arbitrary type. For example, a thermal sensor, a temperature sensor, an optical sensor, a humidity sensor, a vibration sensor, or the like may be connected to the receiver 200. For example, when a sensor is connected to the receiver 200, the sensor is driven by a DC voltage supplied from the electric power management part 203 or by electric power released from the charger 204. The microcomputer 205 continuously or intermittently monitors voltage values at a predetermined part of the receiver 200, states of the sensor which is connected to the receiver 200, and/or information to be detected by the sensor. The microcomputer 205 transmits the voltage value at a predetermined part of the receiver 200, the state of the sensor connected to the receiver 200, and information to be detected by the sensor, as the digital data, to the data transmitting/receiving device 206.

The data transmitting/receiving device 206 is configured to perform processes such as an analog conversion process of digital data supplied from the microcomputer 205 and a modulation process of analog data. Further, the data transmitting/receiving device 206 is configured to perform processes such as a demodulation process of analog data, a digitization process of demodulated analog data. For example, the data transmitting/receiving device 206 is driven by a DC voltage supplied from the electric power management part 203 or by electric power released from the charger 204.

For example, the data transmitting/receiving antenna 207 is configured to be capable of efficiently transmitting and receiving radio waves in a 2.4GHz band. The data transmitting/receiving antenna 207 emits data signals supplied from the data transmitting/receiving device 206. Further, the data transmitting/receiving antenna 207 receives data signals transmitted from the transmitter 100. For example, the data transmitting/receiving antenna 207 is driven by a DC voltage supplied from the electric power management part 203 or by electric power released from the charger 204.

The transmission format of the data signals to be transmitted (or emitted) from the data transmitting/receiving antenna 207 is arbitrary. In a particular example, the data signals emitted from the data transmitting/receiving antenna 207 are radio waves in a 2.4GHz band, and accordingly, these signals may be signals that comply with Bluetooth (registered trademark) or IEEE 802.11x (that is, so-called WIRELESS LAN) format. In such cases, it is preferable that the data transmitting/receiving device 104 of the transmitter 100 also has a function of analyzing the data signals that comply with the format of the data signals to be transmitted from the receiver 200. Alternatively, the first information processing device 300 may be provided with such a function.

### <1.3 Circuit Configuration of Receiver>

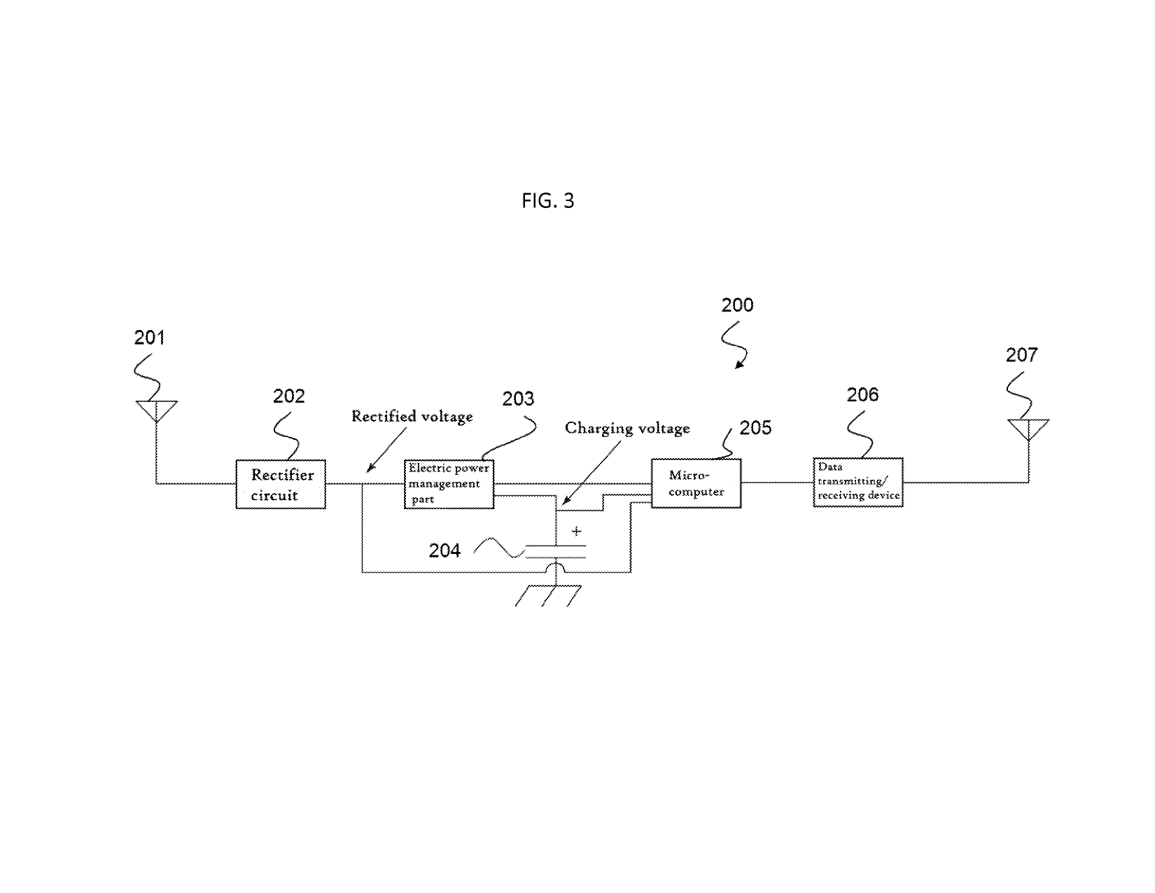

FIG. 3 shows a diagram illustrating an outline of a circuit configuration of the receiver 200 illustrated in FIG. 2.

In the following descriptions, detailed explanations of the configuration elements of the receiver 200 which have been described with referring to FIG. 2 will be omitted. In addition, only main parts of the configuration elements of the receiver 200 in FIG. 2 are illustrated.

In FIG. 3, both of the rectified voltage corresponding to the voltage at a post stage of the rectifier circuit 202 (that is, at an output side of the rectifier circuit 202), and the power supply voltage corresponding to the charging voltage of the charger 204 are inputted to the microcomputer 205, and then these voltages are converted into digital values by an A/D converter which is included in the microcomputer 205 so as to be used in a determination of a power receiving state which will be described later. In the present disclosure, a “predetermined voltage value” detected in the receiver may include, for example, a rectified voltage corresponding to an output of the rectifier, a power supply voltage corresponding to a charging voltage of the charger, or any other voltage measurable within the receiver that is indicative of the power receiving condition. These voltage values may be individually or collectively used as the predetermined voltage value detected and stored in the temporary storage area by the second control module. The predetermined voltage value is therefore not limited to a specific type of voltage, and may encompass any voltage that is detectable within the receiver and usable for determining the power receiving state.

### <1.4 Functional Configuration of Microcomputer 205>

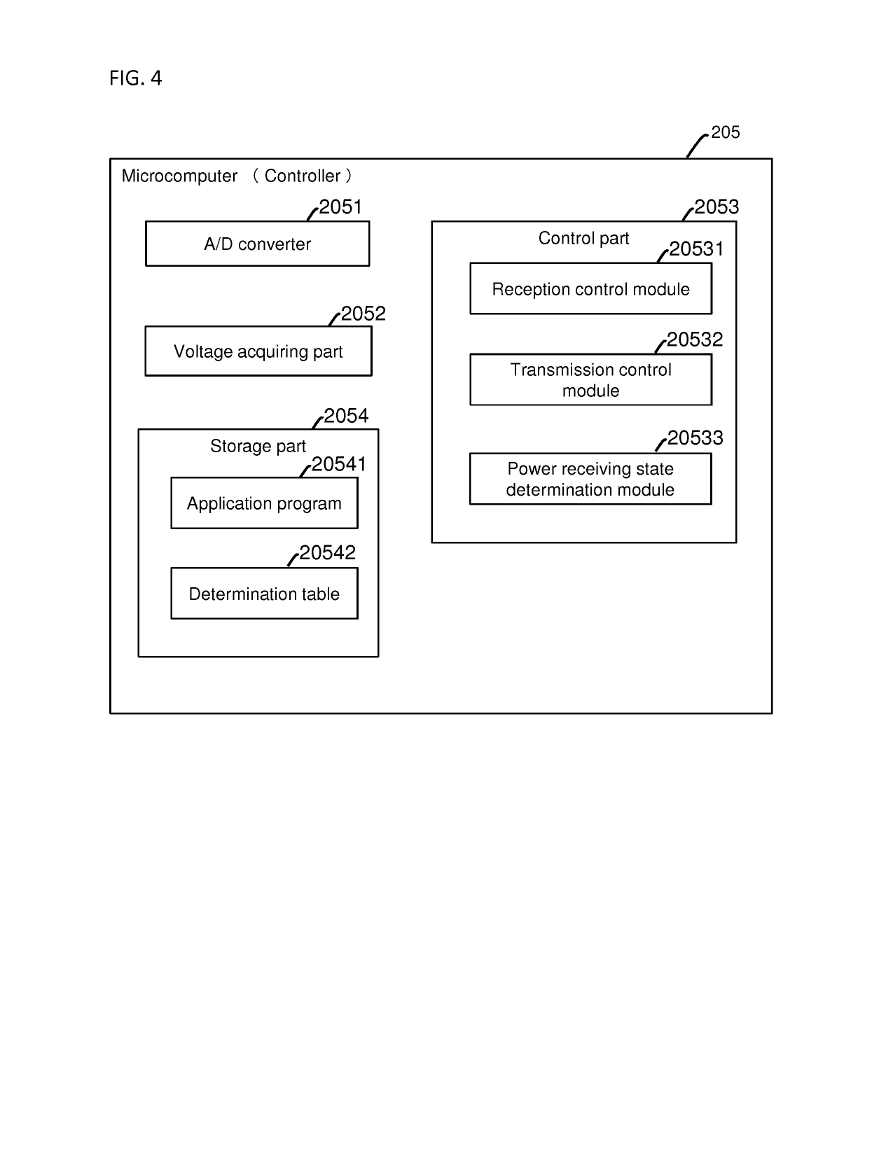

FIG. 4 shows an example giving an explanation of a functional configuration of the microcomputer 205. As illustrated in FIG. 4, the microcomputer 205 exhibits functions of an A/D converter (or A/D conversion part) 2051, a voltage acquiring part 2052, a storage part 2054, and a control part 2053.

The A/D converter 2051 performs processing of converting analog signals, which have been inputted to the microcomputer 205, into digital signals. The A/D converter 2051 may be provided with a circuit capable of functioning as an A/D converter. The A/D converter 2051 according to the present embodiment converts rectified voltages and power supply voltages, both of which are analog signals, into digital values, respectively.

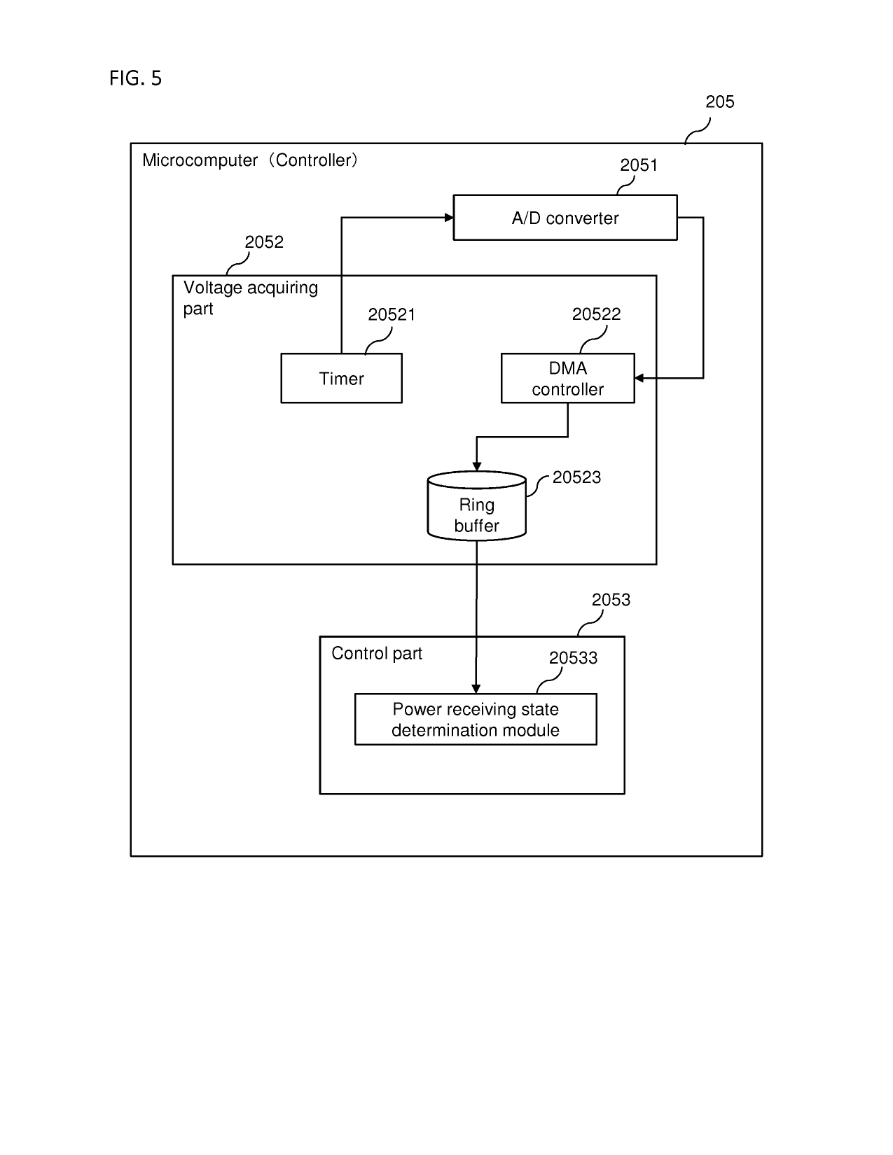

For example, the voltage acquiring part 2052 acquires values, which have been converted from power supply voltages and rectified voltages into digital signals respectively, from the A/D converter 2051. FIG. 5 is a diagram illustrating an example of a configuration of the voltage acquiring part 2052. As illustrated in FIG. 5, the voltage acquiring part 2052 is provided with a timer 20521, a DMA controller 20522, and a ring buffer (or circular buffer) 20523.

In one example, the timer 20521 is constituted of an oscillation circuit, and is used to determine a timing at which digital values of power supply voltage and rectified voltage are acquired. Specifically, the timer 20521 is capable of measuring a time by generating signals at predetermined intervals. In this case, the voltage acquiring part 2052 is capable of acquiring the values of power supply voltage and rectified voltage at an arbitrary timing and at an arbitrary interval. Also, the voltage acquiring part 2052 is capable of acquiring these values periodically or in accordance with a timing when the transmission control module 20532 transmits a physical quantity measured by a sensor, as a data signal, to the transmitter 100 or the like. The term "in accordance with" as used herein also imply that it is capable of acquiring these values in accordance with a timing of transmitting a signal expressing a determination result to the transmitter 100 or the like, nearly concurrently with the data signal, in consideration of a time required for the determination operation to be carried out by the power receiving state determination module 20533 (which will be described later).

In this case, the timing at which the voltage acquiring part 2052 acquires the power supply voltage and the rectified voltage is in accordance with the timing at which the transmission control module 20532 transmits a physical quantity measured by the sensor, as a data signal, to the transmitter 100 or the like. The reason is that the microcomputer 205 consumes a large amount of power by transmitting the data signal, and the power receiving state of the receiver 200 may be appropriately determined by determining the power receiving state of the receiver 200 when the microcomputer 205 consumes electric power. In other words, it is conceivable that the rectified voltage and the power supply voltage increase, when power is fed wirelessly from the transmitter 100, and the power receiving state proceeds in a preferable direction, except when the data signal is transmitted.

In one example, the A/D converter 2051 is provided in association with the timer 20521 of the voltage acquiring part 2052 by a MUX (multiplexer), which is not illustrated, and converts analog signals acquired from an analog power supply terminal (AVDD), which is not illustrated, into digital signals at a timing which is determined by the timer 20521. When it is actually designed, it is possible to use a RFSоC (Radio Frequency System on a chip) having a functional block in which the timer 20521 and the A/D converter 2051 can be associated with each other.

When acquiring analog signals from the analog power supply terminal, the A/D converter 2051 may acquire either one of the rectified voltage or the power supply voltage, one by one (so-called single acquisition), or may acquire both the rectified voltage and the power supply voltage (so-called scan acquisition), and also the A/D converter 2051 may simultaneously receive an input of a reference voltage (for example, a bandgap of 5V), as offset information, from the analog power supply terminal.

A DMA controller 20522 is provided to control transfer of DMA (Direct Memory Access) for transferring data in the microcomputer 205, without activating a processor mounted on the microcomputer 205. The DMA controllers 20522 transmit the digital signals converted by the A/D converter 2051, to the ring buffer 20523.

The ring buffer 20523 is one example of the buffer memory and temporarily stores digital values of the digital signals converted by the A/D converter 2051. The ring buffer 20523 is capable of using its storage area in a circulating way because a tip and an end of the storage area are logically connected to each other. In the present disclosure, the ring buffer described above is an example of a temporary storage area used to temporarily store voltage values acquired within the receiver. The temporary storage area may be implemented not only by a ring buffer but also by any memory area capable of storing the detected voltage values for later use in determining the power receiving state. Accordingly, the temporary storage area is not limited to a particular data structure, and may encompass any storage region that enables the controller to to retain voltage values for later processing.

Returning to FIG. 4, the explanation will be continued. The control part 2053 is realized when the processor mounted on the microcomputer 205 reads an application program 20541 stored in its own storage part 2054, and executes instructions included in the application program 20541. The control part 2053 operates in accordance with the application program 20541, and exhibits functions of the reception control module 20531, the transmission control module 20532, and the power receiving state determination module 20533.

The reception control module 20531 controls a process in which the microcomputer 205 receives signals from an external device such as the transmitter 100 in accordance with a communication protocol.

The transmission control module 20532 controls a process in which the microcomputer 205 transmits signals to an external device such as the transmitter 100 in accordance with a communication protocol.

The power receiving state determination module 20533 compares the digital value of the rectified voltage stored in the ring buffer 20523 with a predetermined threshold value (first threshold value) prescribed for the rectified voltage, and compares the digital value of the power supply voltage acquired by the voltage acquiring part 2052 with a predetermined threshold value (second threshold value) prescribed for the power supply voltage, respectively. Subsequently, the power receiving state determination module 20533 refers to a determination table 20542 stored in the storage part 2054, and determines the power receiving state of the receiver 200 based on the comparison results.

The storage part 2054 includes, for example, the determination table 20542.

The determination table 20542 is a table in which a method of how to determine the power receiving state of the receiver 200 is described with respect to the condition of whether the power supply voltage and the rectified voltage are respectively equal to or less than the threshold values. The determination table 20542 may be previously generated and stored in the storage part 2054 of the microcomputer 205 at the time of manufacturing the receiver 200 or the microcomputer 205, or, the determination table 20542 may be transmitted from at least one of the transmitter 100, the first information processing device 300, and the second information processing device 400 after the receiver 200 is installed.

It is also conceivable that the receiver 200 acquires only the digital values of the rectified voltage and of the power supply voltage, transmits these digital values to the transmitter 100, and then the transmitter 100 and/or the first information processing device 300 and the second information processing device 400 determine the power receiving state of the receiver 200. It is not intended to exclude such a configuration in the WPT system 1 according to the present disclosure.

On the other hand, in a case that the receiver 200 determines its own power receiving state, there is an advantage that the receiver 200 enables to perform detailed operations in a flexible way based on the determination result (for example, to perform an operation to change its own operation state, which will be described below). In addition, as illustrated in FIG. 1, in a case that the transmitter 100 is configured to receive data from a plurality of receivers 200, when the transmitter 100 or the like determines the power receiving states of the respective receivers 200, the computational load of the transmitter 100 or the like will be increased. For the above reasons, in the WPT system 1 according to the present disclosure, the determination of the power receiving state is mainly carried out by the receiver 200.

The first threshold value and the second threshold value, both of which are the basis of the determination of the power receiving state, may be different with each other. For example, the electric power management part 203 may convert the voltage value of the output voltage of the rectifier circuit 202 and supply the converted value to the charger 204 and the microcomputer 205. As a result, the proper value of the rectified voltage, which is the output value from the rectifier circuit 202, may be different from the proper value of the power supply voltage which is associated with the output value from the electric power management part 203. It is possible to appropriately determine the specific values of the first threshold value and the second threshold value according to the circuit configuration of the receiver 200. For example, if the standard value on the circuit design (for example, the output voltage value from the rectifier circuit 202) is 5V, the first threshold value may be set to a value slightly lower than 5V. Similarly, if the output voltage value from the electric power management part 203 is 3.3V, the second threshold value may be set to a value slightly lower than 3.3 V. In addition, it is conceivable that the power supply voltage is the charging voltage to the charger 204 and is the voltage of the operation power source of the microcomputer 205, and accordingly, it is possible to determine the second threshold value as a voltage value which enables to charge the charger 204 and/or a voltage value which enables to operate the microcomputer 205.

The first threshold value and the second threshold value are previously stored in the storage part 2054 of the microcomputer 205. It is also possible to update the first threshold value and the second threshold value based on the data transmissions from the transmitter 100.

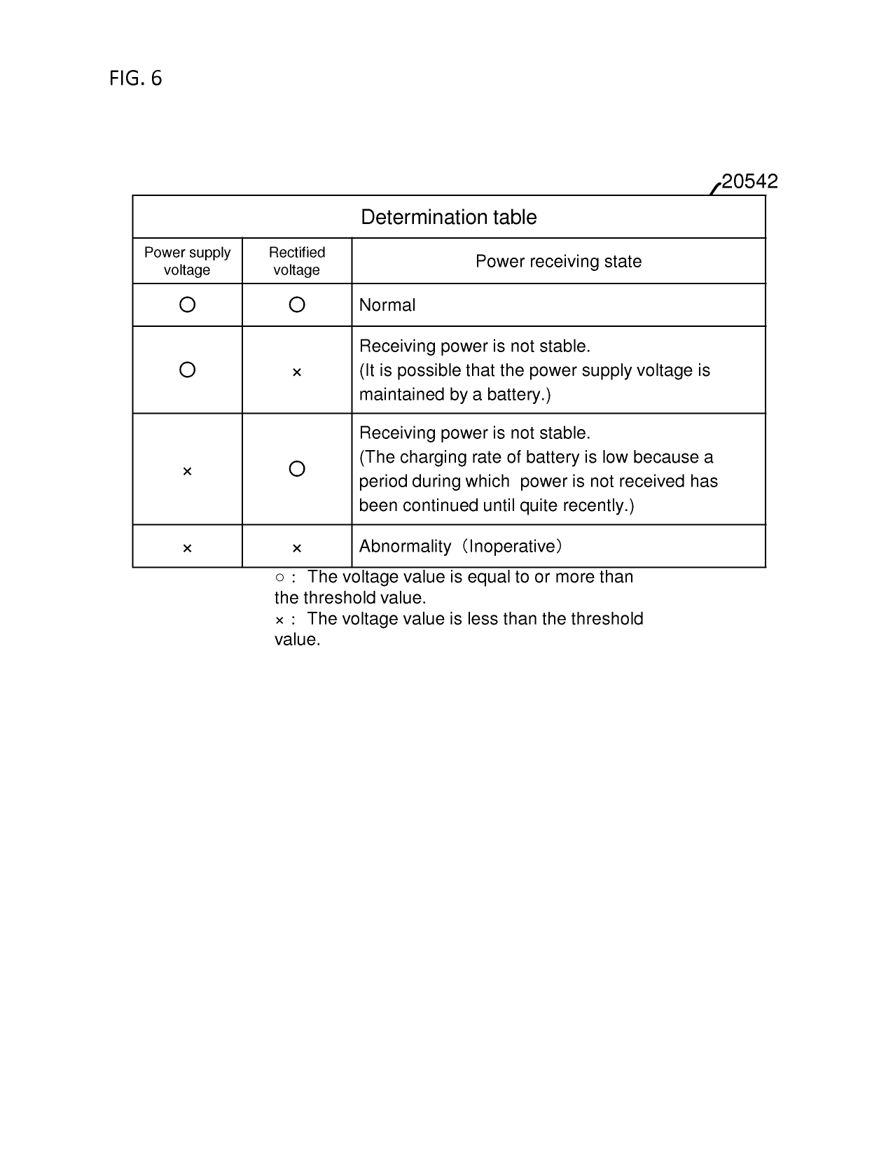

One example of the determination table 20542 to be used by the power receiving state determination module 20533 will be described with referring to FIG. 6. FIG. 5 is a figure illustrating the determination table 20542 stored in the storage part 2054 of the microcomputer 205.

In the determination table 20542, the results of comparing the rectified voltage with the first threshold value and the results of comparing the power supply voltage with the second threshold value, and the association of the determination results of the power receiving states of the receiver 200 based on the above-mentioned comparison results are described. In the example illustrated in FIG. 6, “○” implies that the voltage value is equal to or more than the first threshold value or the second threshold value, and “×” implies that the voltage value is less than the first threshold value or the second threshold value. Since there are two comparison results for the rectified voltage and two comparison results for the power supply voltage, there are four kinds of determination results in the power receiving state.

When at least one of the power supply voltage and the rectified voltage is less than the threshold value, the power receiving state determination module 20533 determines that the power receiving state is not stable.

Following are some concrete examples. In a case that the power supply voltage is “○” and the rectified voltage is “○”, it is determined that the power receiving state is stable and normal.

Next, in a case that the power supply voltage is “○” and the rectified voltage is “×”, it is estimated that power for operating the microcomputer 205 can be secured by the charger 204 at this time. However, since the rectified voltage is “×”, it is estimated that the wireless power feeding from the transmitter 100 is not stable at this time, and accordingly, it is determined that the power supply voltage will be reduced sooner or later due to that the operation of the microcomputer 205 is continued.

Next, in a case that the power supply voltage is “×” and the rectified voltage is “○”, it is determined that, soon, power for operating the microcomputer 205 cannot be secured, due to that a period during which the wireless power feeding is not stable has continued immediately close to the determination time, and that the charging rate (SOC: State Of Charge) of the charger 204 is low.

And in a case that the power supply voltage is “×” and the rectified voltage is “×”, it is determined that the whole receiver 200 cannot operate. However, when the power supply voltage is lower than the operable voltage of the microcomputer 205, the power receiving state determination module 20533 cannot perform its determination operation, and accordingly, the power supply voltage is assumed to be higher than the operable voltage of the microcomputer 205 even if both the power supply voltage and the rectified voltage are “×”.

Subsequently, the power receiving state determination module 20533 transmits the determination result based on the determination table 20522 to the transmitter 100 or the like via the transmission control module 20532. The timing at which the determination result is transmitted is arbitrary. In one example, the determination results may be periodically transmitted in the same way as the timing at which the digital values of the rectified voltage and the power supply voltage are acquired by the voltage acquiring part 2052. In another example, the determination results may be transmitted in accordance with the timing at which the physical quantities to be measured by the sensor are transmitted to the transmitter 100 or the like, as the data signals, by the transmission control module 20532.

The method of transmitting the determination results by the power receiving state determination module 20533 is arbitrary. In one example, only two types of signals for indicating a "normal" and an “abnormality" (the “abnormality” includes both of a "state at which power reception is not stable" and an "abnormality") may be transmitted. In another example, three types of signals for indicating a "normal", a "state at which power reception is not stable" and an "abnormality" may be transmitted. In yet another example, four types of signals for indicating four patterns obtained from the power receiving state determination module 20533 may be transmitted (the four patterns are illustrated in FIG. 6).

### <1.5 Operation Example>

Hereinafter, an example of the operation of the microcomputer 205 will be described.

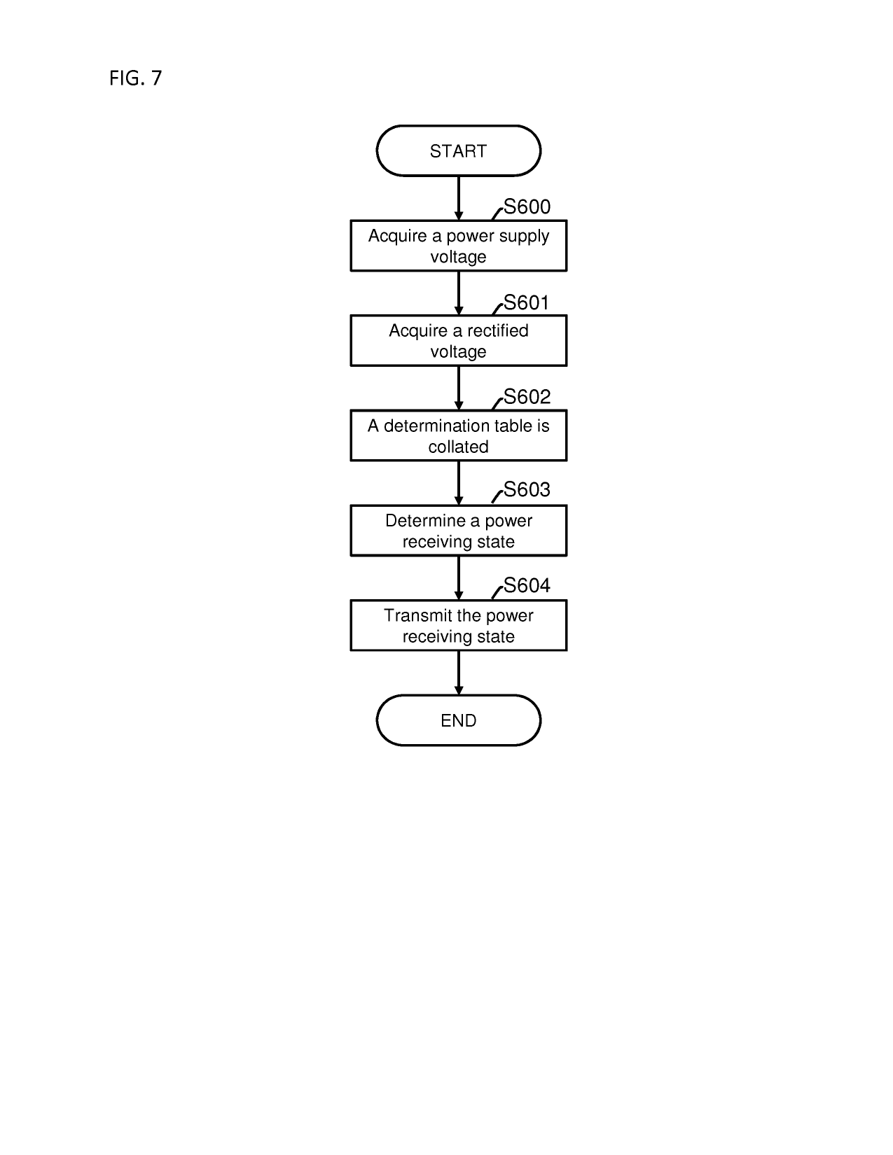

FIG. 7 shows a flowchart of one example of a main operation of the microcomputer 205.

The operation illustrated in the flowchart of FIG. 7 may be started in accordance with a timing based on the timer 20521. The operation order of the respective steps in the flowchart of FIG. 7 is not limited to that example illustrated in the figure, and the operation order may be changed as appropriate. For example, the order of acquiring the power supply voltage and the rectified voltage at steps S600 and S601 is not limited, and these voltages may be acquired asynchronously or simultaneously.

At the step S600 and the step S601, the DMA controller 20522 acquires the digital value of the power supply voltage and that of the rectified voltage from the A/D converter 2051. The DMA controller 20522 stores the acquired digital values of the power supply voltage and the rectified voltage in the ring buffer 20523 at least temporarily.

Subsequently, at the step S602, the control part 2053 collates the voltage values of the power supply voltage and the rectified voltage, which are acquired in the steps S600, S601, with the determination table 20542. Specifically, for example, the control part 2053 causes the power receiving state determination module 20533 to collate the voltage values of the power supply voltage and the rectified voltage, which are acquired in the steps S600, S601, with the determination table 20542. The collating operation using the determination table 20542 at the step S602 does not need to be performed immediately after the steps S600, S601, and may be performed independently from the timing at which the voltages are acquired in the steps S600, S601. Similarly, the operations at the following steps S603, S604 do not need to be performed immediately after the steps S600, S601, and may be performed independently from the timing at which the voltages are acquired in the steps S600, S601.

Then, at the step S603, the control part 2053 determines the power receiving state of the receiver 200 based on the collation result carried out at the step S602. Specifically, for example, the control part 2053 causes the power receiving state determination module 20533 to determine the power receiving state of the receiver 200 based on the collation result in the step S602.

Subsequently, at the step S604, the control part 2053 transmits the determination result obtained in the step S603 to the transmitter 100 or the like. Specifically, for example, the control part 2053 causes the power receiving state determination module 20533 and the transmission control module 20532 to transmit the determination result obtained at the step S603 to the transmitter 100 or the like.

### <1.6 Effects of One Embodiment>

As described above, according to the WPT system 1 of the present embodiment, it is possible to determine the power receiving state of the receiver 200 to which electric power is wirelessly supplied.

Specifically, in the configuration where the voltage values of the power supply voltage and the rectified voltage are sequentially transmitted to the transmitter 100 or the like, the receiver 200 needs to frequently transmit the data to the transmitter 100 or the like, and accordingly, there is a high possibility that the receiver 200 consumes an enormous amount of power. Furthermore, when the transmitter 100 or the like receives the data transmitted from a plurality of receivers 200 as in the configuration illustrated in FIG. 1, there is a high possibility that the computational load of the transmitter 100 or the like increases.

According to the WPT system 1 of the present embodiment, the receiver 200 compares two types of threshold values (that is, the first threshold value and the second threshold value) with the voltage values of the power supply voltage and the rectified voltage, and determines the power receiving state of the receiver 200 based on the comparison results. Therefore, it becomes possible to reduce the respective computational loads of the receiver 200 and the transmitter 100. In addition, since each of the power supply voltage and the rectified voltage is compared with the threshold value, and the power receiving state of the receiver 200 is determined based on the comparison results, it becomes possible to determine the power receiving state of the receiver 200 in detail, with a high degree of accuracy.

Then, based on the determination of the power receiving state, the receiver 200 is able to notify the possibility that the state becomes an abnormal state before the power receiving state of the receiver 200 enters the abnormal state (at which both the power supply voltage and the rectified voltage become “×” in the determination table 20542 of FIG. 5), and as a result, the administrator of the WPT system 1, or the first information processing device 300 and the second information processing device 400 can perform an appropriate management based on the notification. This management may include a process of increasing power to be fed from the transmitter 100 which is wirelessly feeding electric power to the receiver 200, and a process of changing the position of the transmitter 100 and the like, when the power receiving state of the receiver 200 is not stable.

The determination result of the receiving state of the receiver 200 may be acquired at the timing when the WPT system 1 is constructed (in other words, when the transmitter 100 and the receiver 200 are actually arranged) to optimize the number and the arrangement positions of the transmitters 100 and those of the receivers 200 based on the determination result.

Especially, the receiver 200 is provided with a sensor, and a proper position of the sensor can be determined to some extent with respect to the installation space. Therefore, when the number and the arrangement positions of the transmitters 100 are examined and optimized, there is a big advantage for wirelessly transmitting power to the receivers 200 in a proper way.

In addition, even if the manufacturer of the transmitter 100 and the manufacturer of the receiver 200 are different, the power receiving state of the receiver 200 can be appropriately determined regardless of the configuration of the transmitter 100, and thus the connectability during operations can be secured and guaranteed. In other words, the WPT system 1 that is not the best effort type can be configured.

In addition, according to the determination result of the power receiving state of the receiver 200, especially when the power supply voltage is equal to or less than the threshold value, the microcomputer 205 may cause the receiver 200 to function in a power saving mode. That is, when the power supply voltage is equal to or less than the threshold value, there is a high possibility that it becomes difficult to continue the operation of the microcomputer 205 or the like, and therefore, it is preferable to operate the receiver 200 in the power saving mode. In one example of the power saving mode, an interval of transmitting the detection result of a sensor to the transmitter 100 or the like is prolonged. In another example, an interval of flashing a lighting device (for example, a LED for indicating that the receiver 200 is operating) is prolonged. In yet another example, when the microcomputer 205 is provided with a low power consumption mode, the microcomputer 205 is shifted to this low power consumption mode. The threshold value for determining the shift (or transition) to the power saving mode may be different from the second threshold value.

Further, in the present embodiment, the DMA controller 20522 acquires the digital values of the power supply voltage and the rectified voltage, both of which have been converted by the A/D converter 2051, and then transmits them to the ring buffer 20523 to be used in the subsequent determination process of the power receiving state. With such a configuration, it is possible to acquire the power supply voltage and the rectified voltage without constantly starting the processor which functions as the control part 2053, and therefore, the power saving can be realized.

In addition, since the ring buffer is used as a buffer memory for temporarily storing the digital values of the power supply voltage and the rectified voltage, it is possible to use the digital values converted by the A/D converter 2051 for the subsequent processes while suppressing the storage area of the microcomputer 205.

### <1.7 Modifications>

In the WPT system 1 of the present embodiment described above, the microcomputer 205 of the receiver 200 is configured to include the A/D converter 2051. However, in the WPT system 1 of the present embodiment, the configuration for acquiring the digital values of the power supply voltage and the rectified voltage is not limited to this embodiment. In one example, a comparator for performing a comparison between the voltage values and the first and second threshold values may be arranged at an input pre-stage of the microcomputer 205 such that the output values of the comparator are inputted to the microcomputer 205. In this case, the A/D converter 2051 does not need to be provided because the output values of the comparator can be digital values. Alternatively, it is also possible to use a reset IC instead of the comparator.

In this way, a configuration in which the calculation operation for performing the comparison between the first threshold value and the rectified voltage and the comparison between the second threshold value and the power supply voltage is not performed by the internal processing of the microcomputer 205 is also sufficiently possible.

In addition, in the WPT system 1 of the present embodiment described above, the comparison between the first threshold value and the rectified voltage and the comparison between the second threshold value and the power supply voltage are performed, but these first and second threshold values may respectively have a plurality of threshold values. That is, with respect to each of the first threshold value and the second threshold value, the voltage value may have a plurality of different threshold values to determine the power receiving state in detail as followings:

to determine whether the rectified voltage is equal to or less than any one of the threshold values constituting the first threshold value, and whether the power supply voltage is equal to or less than any one of the threshold values constituting the second threshold value, or

to determine whether the rectified voltage is less than any one of the threshold values constituting the first threshold value, and whether the power supply voltage is less than any one of the threshold values constituting the second threshold value. As described above, the operations performed by the microcomputer 205 can also be understood as a series of processing steps executed by the receiver. Although the embodiments explain these operations with reference to functional blocks of the controller, such as the reception control module, the voltage acquiring part, and the power receiving state determination module, the same processing flow may be expressed in the form of method steps. For example, the controller performs a step of controlling transmission and reception of signals with an external device, a step of detecting and temporarily storing a predetermined voltage value in the receiver, and a step of determining the power receiving state based on the stored voltage value. These step-wise operations correspond to the sequence shown in FIG. 7, and may be implemented by software executed by a processor, by dedicated hardware circuits, or by any combination thereof. Thus, the method of determining the power receiving state, as recited in the claims, is merely another expression of the processing operations already described with respect to the controller.

### <2. Second Embodiment>

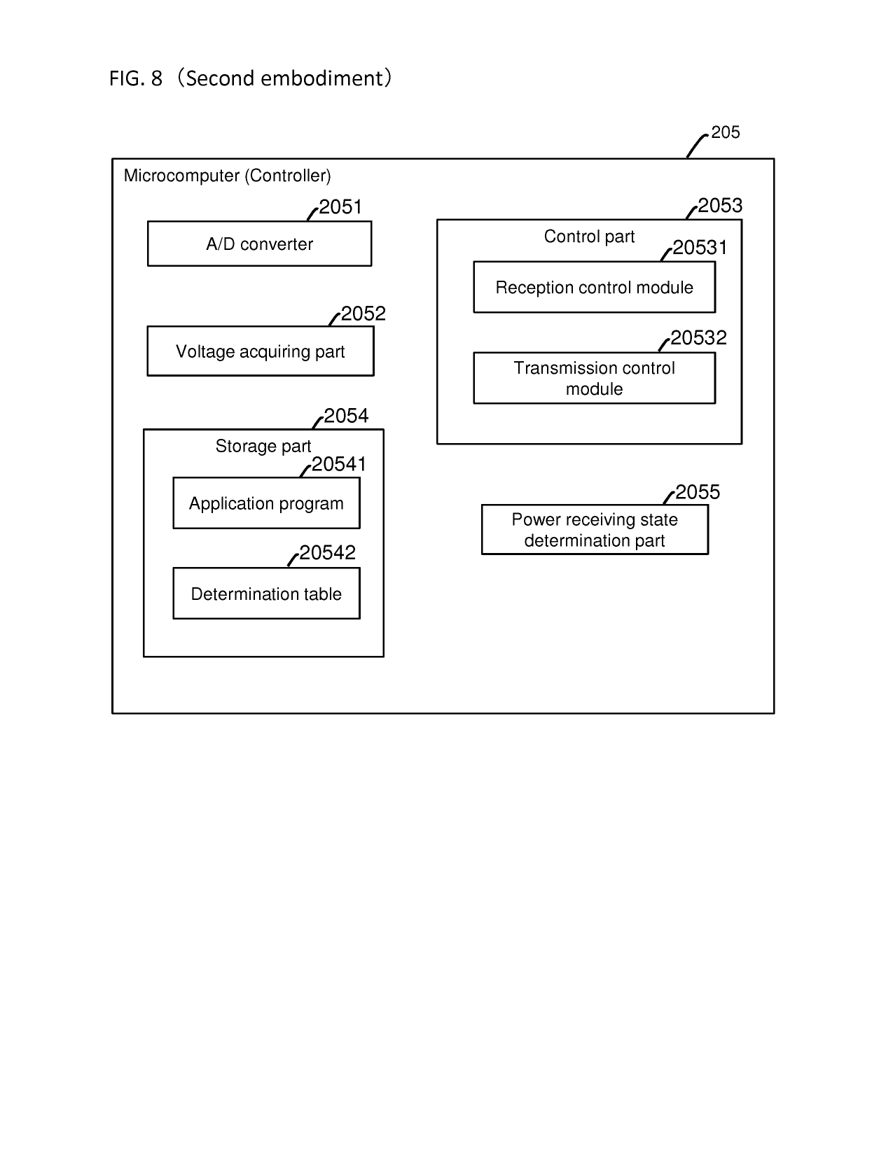

With referring to FIGS. 8 to 15, the second embodiment of the present disclosure will be described. In the first embodiment, the power receiving state of the receiver 200 is determined by the power receiving state determination module 20533 provided in the control part 2053. In contrast to this, in the second embodiment, the power receiving state of the receiver 200 is determined by the power receiving state determination part 2055 which is different from the control part 2053. Hereinafter, differences from the first embodiment will be mainly described.

As illustrated in FIG. 8, the microcomputer 205 of the receiver 200 according to the second embodiment is provided with a power receiving state determination part 2055 different from the control part 2053. That is, the power receiving state determination part 2055 is configured by an electronic circuit different from the processor which functions as the control part 2053. In the present disclosure, the function of determining the power receiving state may be implemented in various forms. For example, in the first embodiment, this function is realized as a functional module executed by the processor included in the controller (that is, the power receiving state determination module 20533). In the second embodiment, this function is realized by the power receiving state determination part 2055, which is configured as a hardware circuit different from the processor. Accordingly, the “third control module” recited in the claims may be implemented either as a software-based functional module executed by the processor or as a hardware circuit such as the power receiving state determination part 2055, or by any combination thereof.

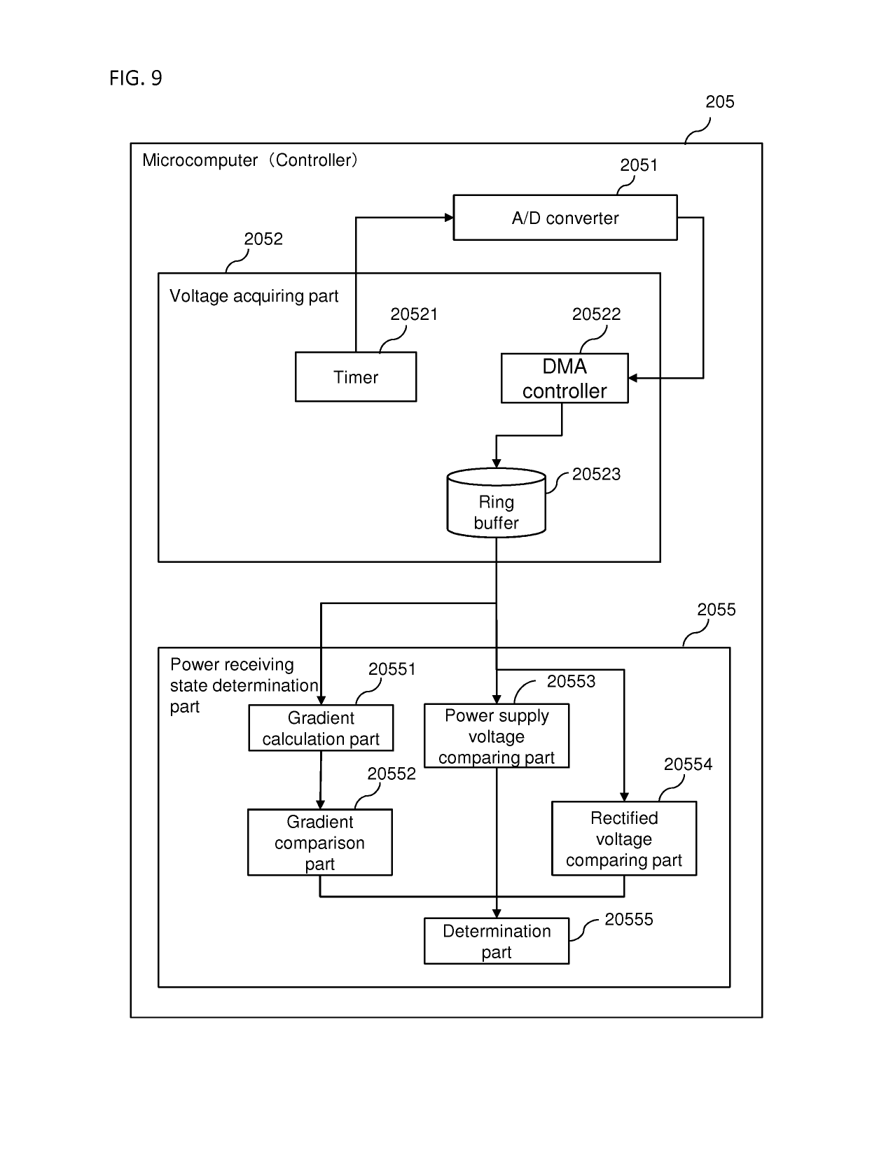

As illustrated in FIG. 9, the power receiving state determination part 2055 includes a gradient calculation part 20551, a gradient comparison part 20552, a power supply voltage comparing part 20553, a rectified voltage comparing part 20554, and a determination part 20555. The power receiving state determination part 2055 carries out the below-mentioned processes based on a digital value of power supply voltage or rectified voltage (hereinafter, also referred to as a power supply voltage value or a rectified voltage value) stored in the ring buffer 20523. In this case, the power receiving state determination part 2055 may be configured to acquire the voltage value stored in the ring buffer 20523 by DMA transfer, executed by the DMA controllers 20522.

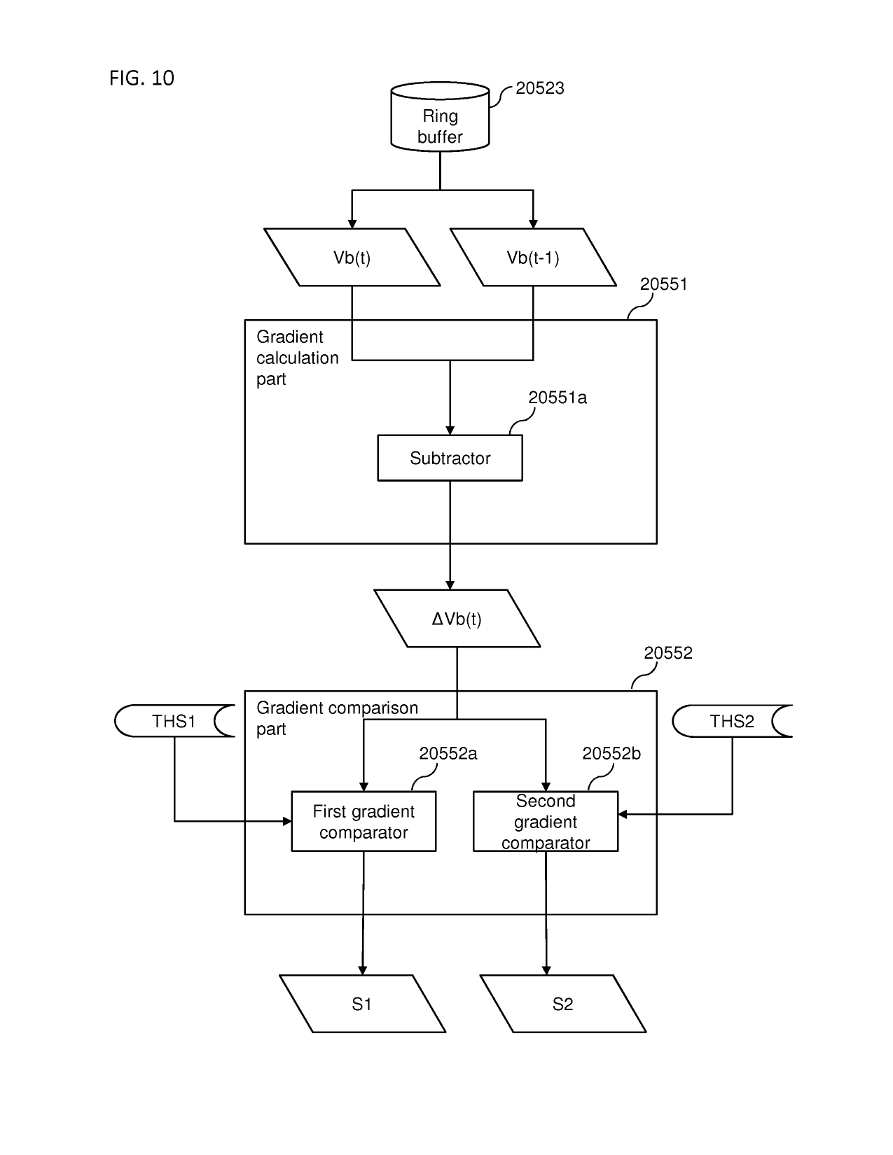

With referring to FIG. 10, a configuration of the gradient calculation part (or gradient calculator) 20551 and that of the gradient comparison part 20552 will be described. The gradient calculation part 20551 calculates a difference (that is, a gradient value) per unit time of power supply voltage values. In one example, the gradient calculation part 20551 is provided with a subtractor 20551a. The subtractor 20551a calculates a gradient value ΔVb (t) of the power supply voltage based on the latest power supply voltage value Vb (t) and the previous power supply voltage value Vb (t-1), which are stored in the ring buffer 20523. For example, in a case that the power supply voltage values are stored in the ring buffer 20523 at regular intervals Δt, the gradient value ΔVb (t) is calculated by dividing the difference value between the power supply voltage value Vb (t) and the previous power supply voltage value Vb (t-1), by the predetermined interval Δt.

The gradient comparison part 20552 compares the gradient value ΔVb (t) which has been calculated by the gradient calculation part 20551 with a predetermined threshold value. In one example, the gradient comparison part 20552 is provided with a first gradient comparator 20552a and a second gradient comparator 20552b. The first gradient comparator 20552a compares the first gradient threshold value THS1 stored in the storage part 2054 with the gradient value ΔVb (t) of the power supply voltage. The second gradient comparator 20552b compares the second gradient threshold value THS2 stored in the storage part 2054 with the gradient value ΔVb (t) of the power supply voltage.

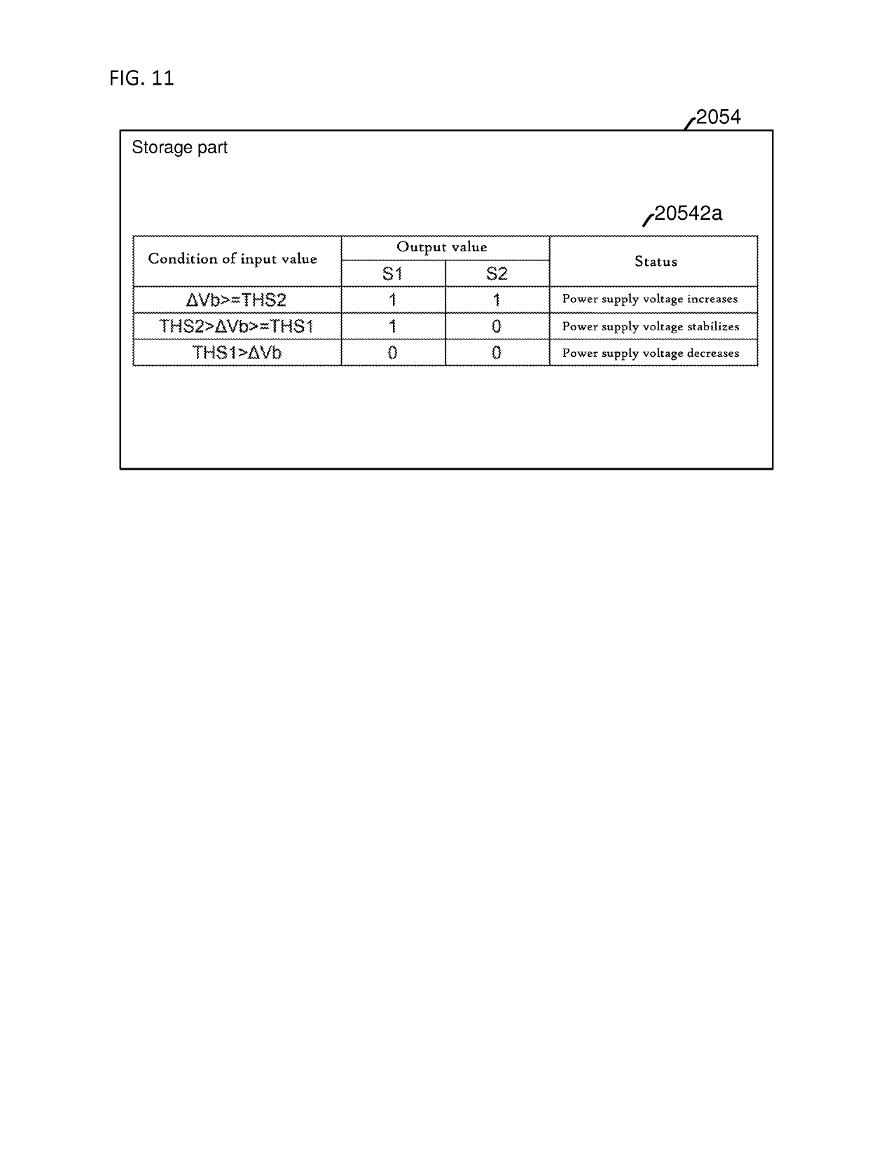

FIG. 11 is a diagram giving an explanation of one example of a gradient determination table 20542a that is one of the determination tables 20542 stored in the storage part 2054. In the gradient determination table 20542a, when the gradient value ΔVb (t) of the power supply voltage satisfies a predetermined condition, the output value is stored. In one example, as illustrated in FIG. 11, when "the gradient value ΔVb (t) of the power supply voltage is equal to or more than (>) the first gradient threshold value THS1", the gradient comparison part 20552 outputs the output value S1 as 1, and otherwise, the gradient comparison part 20552 outputs the output value S1 as 0. In addition, when "the gradient value ΔVb (t) of the power supply voltage is equal to or more than (>) the second gradient threshold value THS2", the gradient comparison part 20552 outputs the output value S2 as 1, and otherwise, the gradient comparison part 20552 outputs the output value S2 as 0.

Thereby, in a case when both the output value S1 and the output value S2 are 1, it can be determined that the status of the power supply voltage is on the “increasing trend”. In a case when the output value S1 is 1 and the output value S2 is 0, it can be determined that the status of the power supply voltage is on the “stabilization trend”. And in a case when both the output value S1 and the output value S2 are 0, it can be determined that the status of the power supply voltage is on the “decreasing trend”. The specific values of the first gradient threshold value THS1 and the second gradient threshold value THS2 may be appropriately set in accordance with the specifications of the receiver 200 or the transmitter 100.

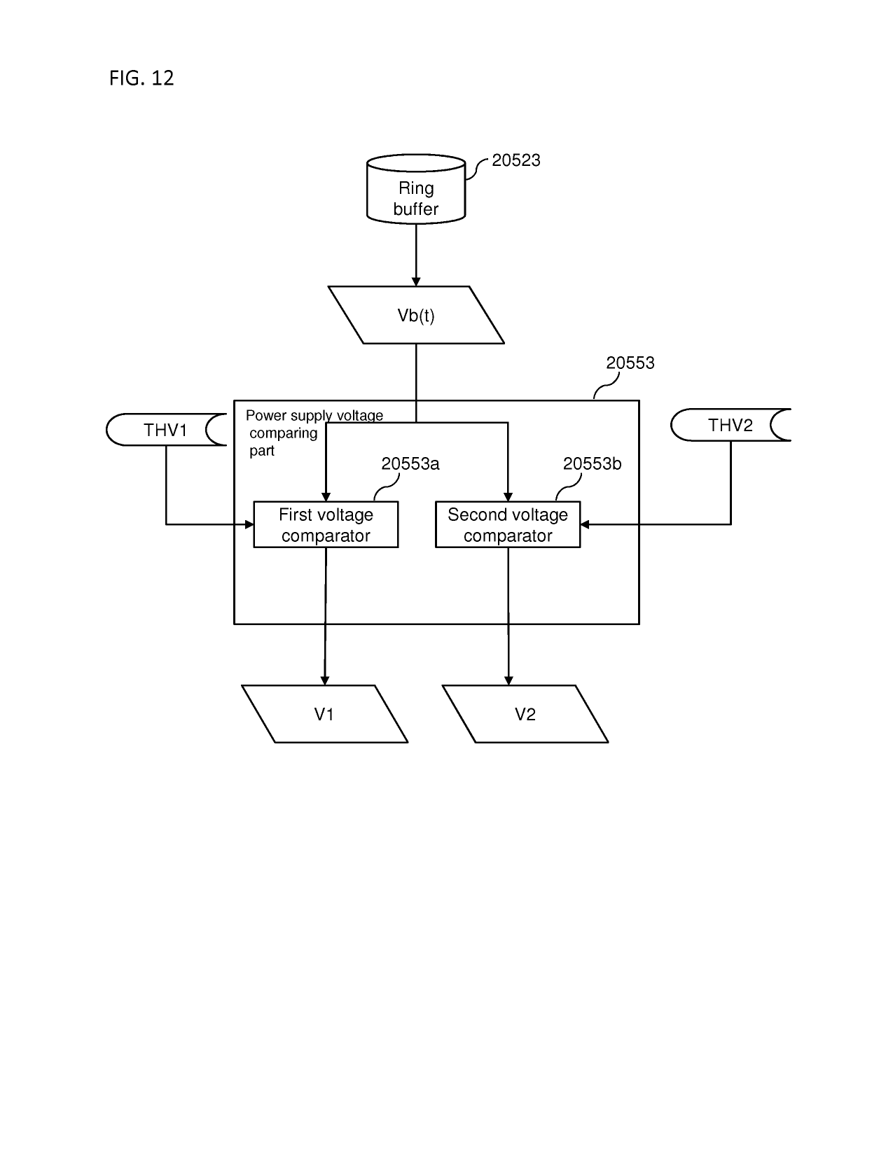

With referring to FIG. 12, a configuration of the power supply voltage comparing part 20553 will be described. The power supply voltage comparing part 20553 compares a latest value of the power supply voltage Vb (t) stored in the ring buffer 20523 with a predetermined threshold value. In one example, the power supply voltage comparing part 20553 is provided with a first voltage comparator 20553a and a second voltage comparator 20553b. The first voltage comparator 20553a compares the power supply voltage Vb (t) with the first voltage threshold value THV1 stored in the storage part 2054. The second gradient comparator 20552b compares the power supply voltage Vb (t) with the second voltage threshold value THV2 stored in the storage part 2054.

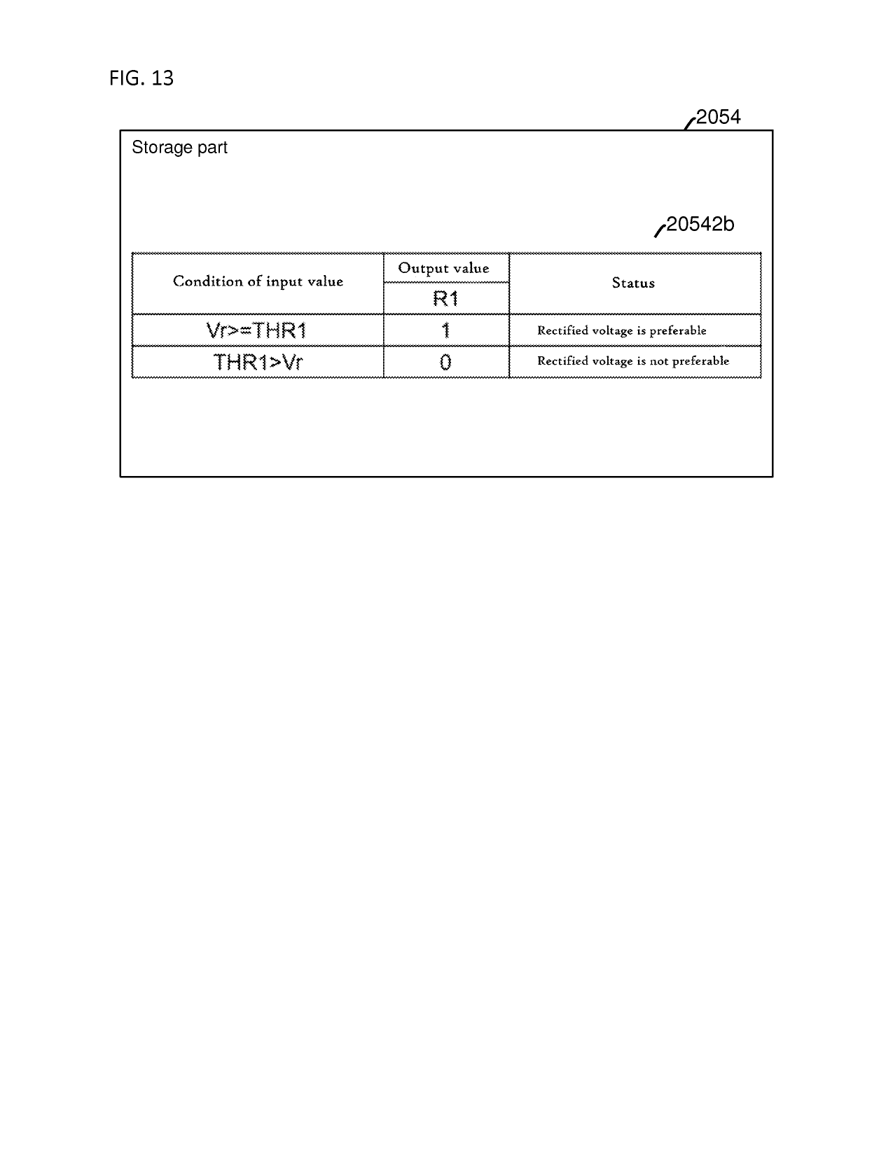

FIG. 13 is a diagram giving an explanation of one example of a voltage determined table 20542b that is one of the determination tables 20542 stored in the storage part 2054. In the voltage determined table 20542b, when the value ΔVb (t) of the power supply voltage satisfies a predetermined condition, the output value is stored. In one example, as illustrated in FIG. 13, when "the value ΔVb (t) of the power supply voltage is equal to or more than (>) the first voltage threshold value THS1", the power supply voltage comparing part 20553 outputs the output value V1 as 1, and otherwise, the power supply voltage comparing part 20553 outputs the output value V1 as 0. In addition, when "the value ΔVb (t) of the power supply voltage is equal to or more than (>) the second gradient threshold value THS2", the power supply voltage comparing part 20553 outputs the output value V2 as 1, and otherwise, the power supply voltage comparing part 20553 outputs the output value V2 as 0.

Thereby, in a case when both the output value V1 and the output value V2 are 1, it can be determined that the status of the power supply voltage is “preferable (or good)”. In a case when the output value V1 is 1 and the output value V2 is 0, it can be determined that the status of the power supply voltage is “normal”. And in a case when both the output value V1 and the output value V2 are 0, it can be determined that the status of the power supply voltage is “not preferable (or poor)”. The specific values of the voltage threshold value THV1 and the second voltage threshold value THV2 may be appropriately set in accordance with the specifications of the receiver 200 or the transmitter 100.

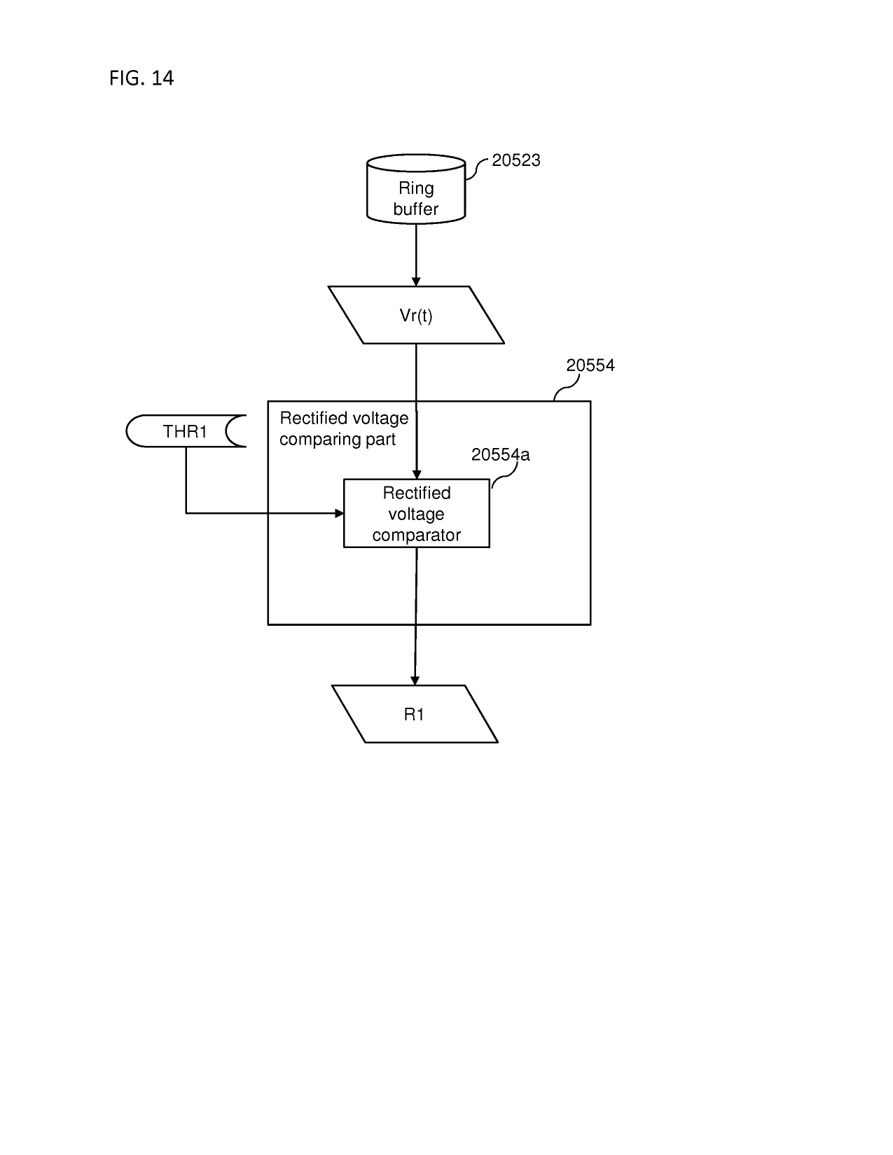

With referring to FIG. 14, a configuration of the rectified voltage comparing part 20554 will be described. The rectified voltage comparing part 20554 compares a latest value of the rectified voltage Vr (t) stored in the ring buffer 20523 with a predetermined threshold value. In one example, the rectified voltage comparing part 20554 is provided with a rectified voltage comparator 20554a. The rectified voltage comparator 20554a compares the rectified voltage Vr (t) with a rectified voltage threshold value THR1 stored in the storage part 2054.

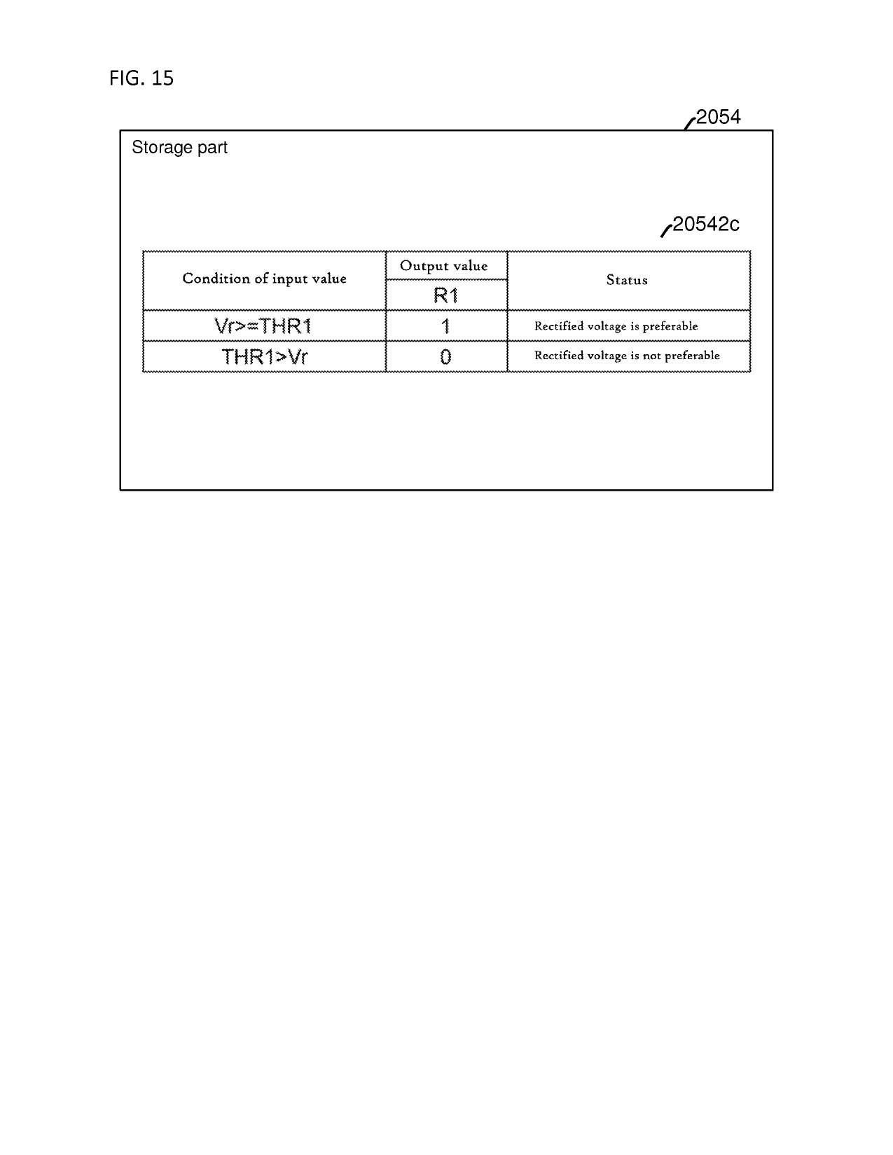

FIG. 15 is a diagram giving an explanation of one example of a rectified voltage determined table 20542c that is one of the determination tables 20542 stored in the storage part 2054. In the rectified voltage determined table 20542c, when the value ΔVb (t) of the rectified voltage satisfies a predetermined condition, the output value is stored. In one example, as illustrated in FIG. 15, when "the value ΔVr (t) of the rectified voltage is equal to or more than (>) the rectified voltage threshold value THR1", the rectified voltage comparing part 20554 outputs the output value R1 as 1, and otherwise, the rectified voltage comparing part 20554 outputs the output value R1 as 0.

Thereby, in a case of the output value R1 is 1, it can be determined that the status of the rectified voltage is “preferable (or good)”. In a case when the output value R1 is 0, it can be determined that the status of the rectified voltage is “not preferable (or poor)”. The specific values of the rectified voltage threshold value THR1 and the rectified voltage threshold value THR2 may be appropriately set in accordance with the specifications of the receiver 200 or the transmitter 100.

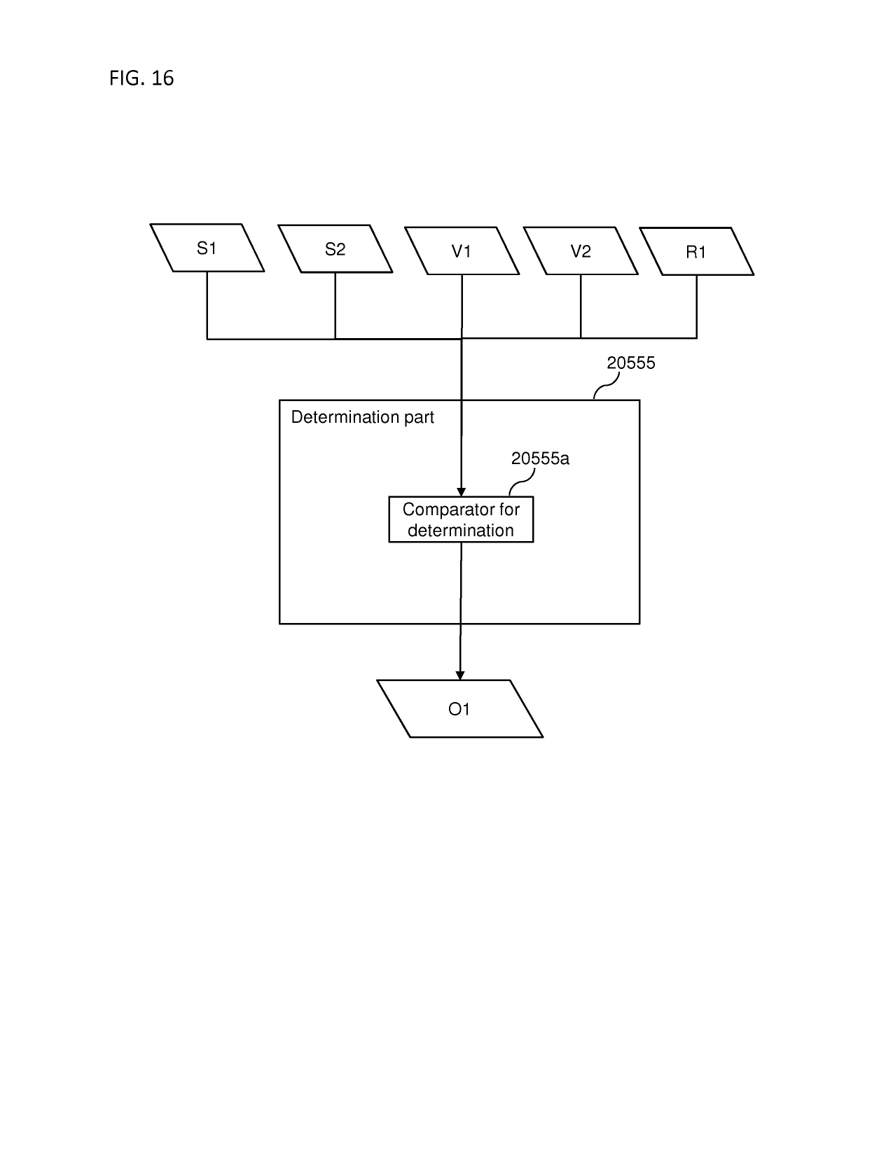

With referring to FIG. 16, a configuration of the determination part 20555 will be described. The determination part 20555 determines the power receiving state of the receiver 200 based on the output value S1 and the output value S2 (both of which are outputted from the gradient comparison part 20552), the output value V1 and the output value V2 (both of which are outputted from the power supply voltage comparing part 20553), and the output value R1 (which is outputted from the rectified voltage comparing part 20554). In one example, the determination part 20555 is provided with a comparator 20555a for determination.

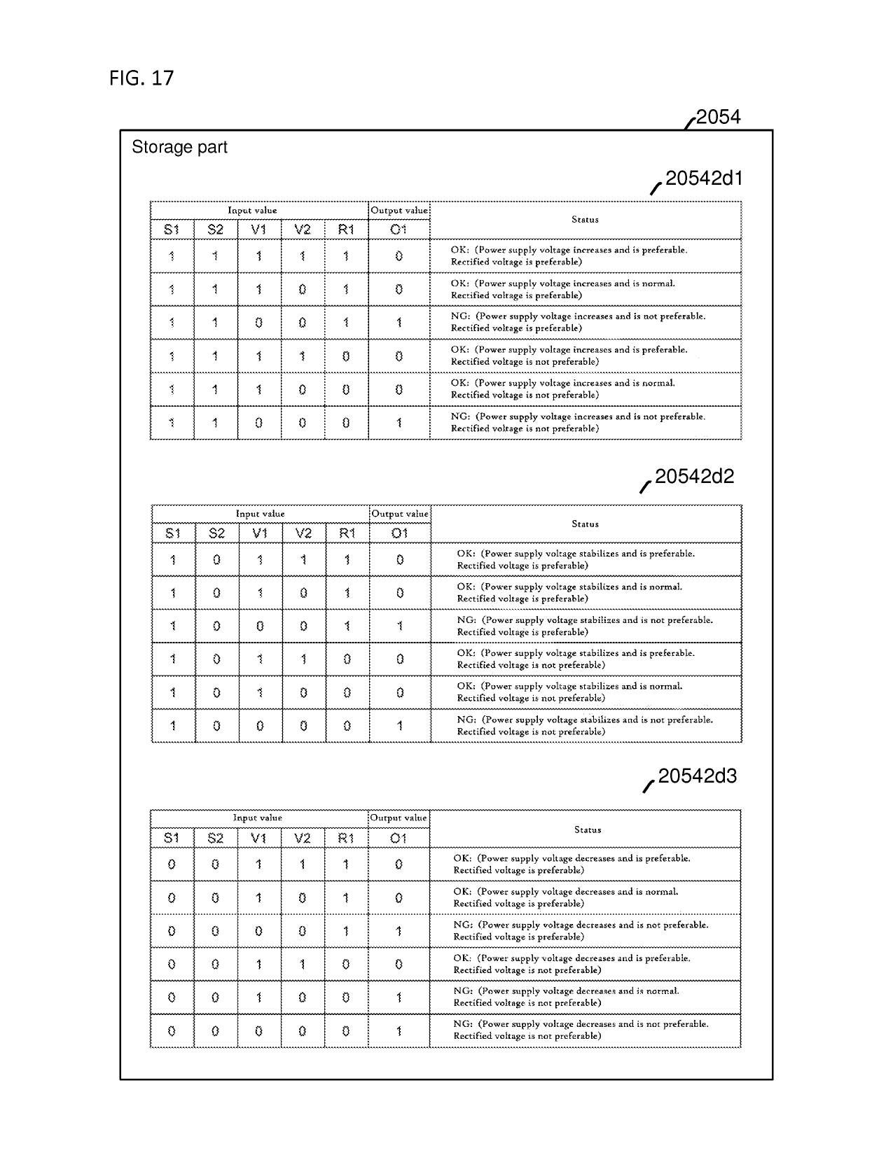

FIG. 17 is a diagram giving an explanation of one example of a power receiving state determination table 20542d that is one of the determination tables 20542 stored in the storage part 2054. The power receiving state determination table 20542d stores a relationship between the values of the S1, S2, V1, V2, and R1, each of which is received as the input value, and the output value O1. For example, in FIG. 17, it is illustrated that the power receiving state determination table 20542d is divided into three parts (in other words, into power receiving state determination tables 20542d1 to 20542d3), from a viewpoint of the visibility.

In one example, in a case when both the S1 and the S2 are 1 (that is, the power supply voltage is on the increasing trend), both the V1 and the V2 are 1 (that is, the power supply voltage is preferable), and the R1 is 1 (that is, the rectified voltage is preferable), the output value O1 is outputted as 0. Also, in a case when both the S1 and the S2 are 1 (that is, the power supply voltage is on the increasing trend), both the V1 and the V2 are 0 (that is, the power supply voltage is not preferable), and the R1 is 1 (that is, the rectified voltage is preferable), the output value O1 is outputted as 1.

In a case when the output-value О1 is 0, it implies that the power receiving state of the receiver 200 is normal. And in a case when the О1 is 1, it implies that the power receiving state of the receiver 200 is not preferable. Thus, when the output value О1 becomes 1 as described above, the processor which functions as the control part 2053 may be activated to execute a predetermined process in a case where a power receiving state is not preferable (for example, to execute a process of switching to the power saving mode).

In this way, in the second embodiment of the present disclosure, it is possible to determine the power receiving state of the receiver 200 without activating the processor, and therefore, power saving in the receiver 200 can be realized.

Further, in the present embodiment, the gradient calculation part 20551 calculates the gradient value of the power supply voltage to determine the power receiving state in consideration of whether the power supply voltage is on the increasing trend or the decreasing trend. As described above, it is possible to estimate the status of the power supply voltage in the future by determining the power receiving state of the receiver 200 based on the value of the power supply voltage, the increasing trend/decreasing trend of the power supply voltage, and the value of the rectified voltage. For example, if the rectified voltage exceeds the first threshold value while the power supply voltage is on the decreasing trend, it can be determined that the power supply voltage will be restored and the current decreasing trend will not continue (in other words, a reduction in the power supply voltage is not expected in the future). As described above, the function of determining the power receiving state of the receiver may be realized in various forms depending on the implementation of the controller. In the first embodiment, this function is performed by a processor executing software included in the control part 2053, whereas in the second embodiment, the same function is realized by a dedicated hardware circuit, namely the power receiving state determination part 2055. As is apparent from these embodiments, the functional block that executes the determination of the power receiving state corresponds to the “third control module” recited in the claims, regardless of whether it is implemented by software executed by a processor, by a hardware circuit, or by any combination thereof. In this sense, the electronic circuit such as the power receiving state determination part 2055 may constitute the third control module of the controller, depending on the implementation.

It is possible to further provide a definition consisting of two stages to the increasing trend/decreasing trend of the power supply voltage. In other words, it is possible to set a threshold value at a slope of the increasing trend/decreasing trend of the power supply voltage to change the definition of the status depending on whether there is an increasing trend/decreasing trend in the power supply voltage having a value exceeding the threshold value. The number of the threshold values relating to the slope of the increasing trend/decreasing trend of the power supply voltage can be arbitrarily set.

### <3. Additional Remarks>

The above-described embodiments have been described in detail to provide an explanation of configurations easier to be understood. These embodiments are not necessarily limited to those having all the described configurations. In addition, it is possible to add, delete, or replace a part of a configuration with another configuration, for each embodiment.

As one example, in each of the above-described embodiments, the receiver 200 is configured to mainly perform the determination of the power receiving state of the receiver, but it is also possible to configure the receiver 200 to transmit values (digital values) of the rectified voltage and the power supply voltage as signals to the transmitter 100 and the first information processing device 300, and to configure the transmitter 100 and the first information processing device 300 to perform the determination of the power receiving state of the receiver 200 based on the values such as the rectified voltage transmitted from the receiver 200. That is, in the example illustrated in FIG. 4, it is possible to configure the transmitter 100 and/or the first information processing device 300 to be provided with the power receiving state determination module 20533, and to configure the transmission control module 20532 to transmit the rectified voltage and the power supply voltage, each of which is acquired by the voltage acquisition part 2052, to the transmitter 100 and/or the first information processing device 300

In the above-described embodiments, a system for wirelessly transmitting a transmission power consisting of AC signals from the transmitter 100 to the receiver 200, in other words, so-called WPT system 1 has been explained. However, it is also possible to configure a system to feed electric power to the receiver 200 by other methods. Since such a system is known, a detailed description thereof will be omitted, but as examples, a system for transmitting electric power generated by photovoltaic power generation device to the receiver 200 (regardless wired or wireless) and a system for transmitting electric power by laser light to the receiver 200 (regardless wired or wireless) can be cited. In addition, it is also applicable that sounds or vibrations are made to be transmitted to the receiver 200 and the receiver 200 is configured to convert such power (vibrations or the like) to electric power. Further, known other systems different from the one for wirelessly receiving transmitting power consisting of AC signals are also applicable, and for example, known contactless power feeding techniques such as systems for contactlessly feeding electric power by using a magnetic field coupling method are also applicable.

In addition, some or all of the above-described configurations, functions, processing parts, processing means, and the like may be realized by a hardware, for example, by designing them with an integrated circuit. In addition, the present invention may also be realized by program codes of a software which are capable of realizing the functions of the embodiments. In such cases, a computer is provided with a storage medium in which the program codes are recorded such that the program code stored in the storage medium are made to be read by a processor included in the computer. When the program codes are read from the storage medium, the program codes themselves realize the functions of the above-described embodiments. Hence, it is conceivable that the program codes and the storage medium storing the program codes can constitute the present invention. As examples of the storage medium for providing such program codes, a flexible disk, a CD-ROM, a DVD-ROM, a hard disk, an SSD, an optical disk, a magneto-optical disk, a CD-R, a magnetic tape, a nonvolatile memory card, and a ROM can be cited.

Also, the program codes for realizing the functions described in the present embodiments can be implemented by various kinds of programs or scripting languages, such as the assembler, C/C++, perl, Shell, PHP, and Java (registered trademark).

Further, it is possible to distribute the program codes of a software for realizing the functions of the present embodiments through a network such that the program codes are stored in a storage means (for example, a hard disk or a memory of a computer or a storage medium such as a CD-RW, a CD-R) to make a processor included in the computer to read and execute the program codes stored in the storage means or the storage medium.

The above-mentioned embodiments include the following configurations.

### [Configuration 1]

A receiver for wirelessly receiving transmitting power composed of AC signals is provided, and the receiver includes:

a rectifier for rectifying the transmitting power;

an electric power management part for managing a rectified voltage from the rectifier;

a charger to be electrically charged with an output voltage from the electric power management part; and

a controller for controlling operations of the receiver.

The controller executes a step of detecting a predetermined voltage value in the receiver, and a step of storing the voltage value detected in the above-mentioned detecting step in a buffer memory by a DMA (Direct Memory Access).

### [Configuration 2]

The receiver according to the configuration 1 is also provided, wherein, in the above-mentioned detecting step, the controller detects the rectified voltage and the power supply voltage which is a charging voltage of the charger, compares the rectified voltage with a first threshold value prescribed for the rectified voltage, and compares the power supply voltage with a second threshold value prescribed for the power supply voltage.

### [Configuration 3]

The receiver according to the configuration 2 is also provided, wherein the controller determines a power receiving state of the receiver based on at least one of the comparison results.

### [Configuration 4]

The receiver according to any one of the configurations 1 to 3 is also provided, wherein the controller acquires a digital value by performing A/D conversion on the detected predetermined voltage value, and stores the acquired A/D conversion value in a ring buffer as the buffer memory.

### [Configuration 5]

The receiver according to the configuration 4 is also provided, wherein the controller is provided with a timer for determining a timing of acquiring the digital-value, and a converter for performing the A/D conversion is associated with the timer.

### [Configuration 6]

The receiver according to the configuration 2 or 3 is also provided, wherein the controller compares the detected rectified voltage with the first threshold value prescribed for the rectified voltage and compares the detected power supply voltage with the second threshold value prescribed for the power supply voltage, and determines the power receiving state of the receiver based on at least one of the comparison results, without activating the processor.

### [Configuration 7]

The receiver according to the configuration 6 is also provided, wherein a subtractor and a comparator are used for comparing the rectified voltage and the power supply voltage with the corresponding threshold values which are prescribed for the respective voltages, to determine a power receiving state of the receiver.

The present disclosure includes the following appended configurations.

[Note 1]

A receiver for receiving microwave power wirelessly, the receiver comprising:

a rectifier for rectifying transmitting power;

an electric power management device for managing a rectified voltage from the rectifier;

a charger to be electrically charged with an output voltage from the electric power management device; and

a controller configured to control the rectifier, the electric power management device, and the charger,

wherein the controller includes a first control module, a second control module, and a third control module,

wherein the first control module controls transmission and reception of signals between the controller and an external device,

wherein the second control module detects a predetermined voltage value in the receiver and stores the detected voltage value in a temporary storage area, and

wherein the third control module determines a power receiving state of the receiver based on the voltage value stored in the temporary storage area.

[Note 2]

The receiver according to Note 1,

wherein the second control module detects a rectified voltage and a power supply voltage which is a charging voltage of the charger, and

wherein the third control module compares the detected rectified voltage with a first threshold value predetermined for the rectified voltage and compares the detected power supply voltage with a second threshold value predetermined for the power supply voltage.

[Note 3]

The receiver according to Note 2,

wherein the third control module determines the power receiving state of the receiver based on at least one of the comparison results.

[Note 4]

The receiver according to Note 1,

wherein the second control module performs A/D conversion on the detected predetermined voltage value to acquire a digital value, and stores the digital value acquired by A/D conversion in a ring buffer serving as the buffer memory.

[Note 5]

The receiver according to Note 4,

wherein the second control module includes a timer for defining a timing for acquiring the digital value, and the converter for performing the A/D conversion acquires the digital value by a predetermined timing of the timer.

[Note 6]

The receiver according to Note 2,

wherein the third control module compares the detected rectified voltage with the first threshold value predetermined for the rectified voltage, compares the detected power supply voltage with the second threshold value predetermined for the power supply voltage, and determines the power receiving state of the receiver based on at least one of the comparison results without activating the first control module.

[Note 7]

The receiver according to Note 6,

wherein the third control module uses a subtractor and a comparator to compare the rectified voltage and the power supply voltage with the respective threshold values predetermined for the voltages, and determines the power receiving state of the receiver.

[Note 8]

The receiver according to Note 1,

wherein the receiver receives microwaves having a frequency of 0.9 GHz or higher,

wherein the second control module detects the predetermined voltage value in the receiver at a plurality of timings, and

wherein the third control module determines the power receiving state of the receiver based on the voltage values detected at the plurality of timings.

[Note 9]

The receiver according to Note 8,

wherein the third control module includes a gradient calculation device configured to calculate, from the voltage values detected at the plurality of timings and acquired from the temporary storage area, a gradient value representing a difference per unit time of the voltage value; and

a gradient comparison device configured to compare the calculated gradient value with a predetermined threshold value.

[Note 10]

An electronic circuit for operating a receiver that receives microwave power wirelessly,

the receiver comprising a rectifier for rectifying transmitting power, an electric power management device for managing a rectified voltage from the rectifier, a charger to be electrically charged with an output voltage from the electric power management device, and a controller configured to control the rectifier, the electric power management device, and the charger,

wherein the controller includes a first control module and a second control module, and includes the electronic circuit as a third control module,

wherein the first control module controls transmission and reception of signals between the controller and an external device,

wherein the second control module detects a predetermined voltage value in the receiver and stores the detected voltage value in a temporary storage area, and

wherein the electronic circuit determines a power receiving state of the receiver based on the voltage value stored in the temporary storage area.

[Note 11]

The electronic circuit according to Note 10,

wherein the receiver receives microwaves having a frequency of 0.9 GHz or higher,

wherein the second control module detects the predetermined voltage value in the receiver at a plurality of timings, and

wherein the electronic circuit determines the power receiving state of the receiver based on the voltage values detected at the plurality of timings.

[Note 12]

The electronic circuit according to Note 11,

wherein the electronic circuit includes a gradient calculation device configured to calculate, from the voltage values detected at the plurality of timings and acquired from the temporary storage area, a gradient value representing a difference per unit time of the voltage value; and

a gradient comparison device configured to compare the calculated gradient value with a predetermined threshold value.

[Note 13]

A method for determining a power receiving state, the method being executed by a receiver configured to receive microwave power wirelessly,

the receiver comprising a rectifier for rectifying transmitting power, an electric power management device for managing a rectified voltage from the rectifier, a charger to be electrically charged with an output voltage from the electric power management device, and a controller configured to control the rectifier, the electric power management device, and the charger,

wherein the controller executes a first control step, a second control step, and a third control step,

wherein, in the first control step, the controller controls transmission and reception of signals between the controller and an external device,

wherein, in the second control step, the controller detects a predetermined voltage value in the receiver and stores the detected voltage value in a temporary storage area, and

wherein, in the third control step, the controller determines the power receiving state of the receiver based on the voltage value stored in the temporary storage area.

[Note 14]

The method for determining a power receiving state according to Note 13,

wherein the receiver receives microwaves having a frequency of 0.9 GHz or higher,

wherein, in the second control step, the controller detects the predetermined voltage value in the receiver at a plurality of timings, and

wherein, in the third control step, the controller determines the power receiving state of the receiver based on the voltage values detected at the plurality of timings.

[Note 15]

The method for determining a power receiving state according to Note 14,

wherein, in the third control step, the controller executes a gradient calculation step configured to calculate, from the voltage values detected at the plurality of timings and acquired from the temporary storage area, a gradient value representing a difference per unit time of the voltage value, and a gradient comparison step configured to compare the calculated gradient value with a predetermined threshold value.

### [Explanation of Reference numerals]

1: WPT system,

100 : Transmitter,

101 : Oscillator,

102 : Transmitting antenna,

103 : Microcomputer,

104 : Data transmitting/receiving device,

105 : Data transmitting/receiving antenna,

200 : Receiver,

201 : Receiving antenna,

202 : Rectifier circuit,

203 : Electric power management part (or power manager),

204 : Charger,

205 : Microcomputer,

206 : Data transmitting/receiving device,

207 : Data transmitting /receiving antenna,

300 : First information processing device,

400 : Second information processing device,

2051: A/D converter (or A/D conversion part),

2052 : Voltage acquiring part,

20521 : Timer,

20522: DMA controller,

20523 : Ring buffer,

2053 : Control part,

20531 : Reception control module

20532, Transmission control module,

20533 : Power receiving state determination module,

2054 : Storage part,

20541 : Application program,

20542 : Determination table,

20542a: Gradient determination table,

20542b: Voltage determination table,

20542c: Rectified voltage determined table,

20542d: Power receiving state determination table,

2055: Power receiving state determination part,

20551: Gradient calculation part (gradient calculator),

20551a: Subtractor,

20552: Gradient comparison part,

20552a: First gradient comparator,

20552b: Second gradient comparator,

20553: Power supply voltage comparing part,

20553a: First voltage comparator,

20553b: Second voltage comparator,

20554: Rectified voltage comparing part,

20554a: Rectified voltage comparator,

20555: Determination part, and

20555a: Comparator for determination.

What is claimed is:

1. A receiver for receiving microwave power wirelessly, the receiver comprising:
a rectifier for rectifying transmitting power;
an electric power management device for managing a rectified voltage from the rectifier;
a charger to be electrically charged with an output voltage from the electric power management device; and
a controller configured to control the rectifier, the electric power management device, and the charger,
wherein the controller includes a first control module, a second control module, and a third control module,
wherein the first control module controls transmission and reception of signals between the controller and an external device,
wherein the second control module detects a predetermined voltage value in the receiver and stores the detected voltage value in a temporary storage area, and
wherein the third control module determines a power receiving state of the receiver based on the voltage value stored in the temporary storage area.

2. The receiver according to claim 1,
wherein the second control module detects a rectified voltage and a power supply voltage which is a charging voltage of the charger, and
wherein the third control module compares the detected rectified voltage with a first threshold value predetermined for the rectified voltage and compares the detected power supply voltage with a second threshold value predetermined for the power supply voltage.

3. The receiver according to claim 2,
wherein the third control module determines the power receiving state of the receiver based on at least one of the comparison results.

4. The receiver according to claim 1,
wherein the second control module performs A/D conversion on the detected predetermined voltage value to acquire a digital value, and stores the digital value acquired by A/D conversion in a ring buffer serving as the buffer memory.

5. The receiver according to claim 4,
wherein the second control module includes a timer for defining a timing for acquiring the digital value, and the converter for performing the A/D conversion acquires the digital value by a predetermined timing of the timer.

6. The receiver according to claim 2,
wherein the third control module compares the detected rectified voltage with the first threshold value predetermined for the rectified voltage, compares the detected power supply voltage with the second threshold value predetermined for the power supply voltage, and determines the power receiving state of the receiver based on at least one of the comparison results without activating the first control module.

7. The receiver according to claim 6,
wherein the third control module uses a subtractor and a comparator to compare the rectified voltage and the power supply voltage with the respective threshold values predetermined for the voltages, and determines the power receiving state of the receiver.

8. The receiver according to claim 1,
wherein the receiver receives microwaves having a frequency of 0.9 GHz or higher,
wherein the second control module detects the predetermined voltage value in the receiver at a plurality of timings, and
wherein the third control module determines the power receiving state of the receiver based on the voltage values detected at the plurality of timings.

9. The receiver according to claim 8,
wherein the third control module includes:
a gradient calculation device configured to calculate, from the voltage values detected at the plurality of timings and acquired from the temporary storage area, a gradient value representing a difference per unit time of the voltage value; and
a gradient comparison device configured to compare the calculated gradient value with a predetermined threshold value.

10. An electronic circuit for operating a receiver that receives microwave power wirelessly,
the receiver comprising:
a rectifier for rectifying transmitting power;
an electric power management device for managing a rectified voltage from the rectifier;
a charger to be electrically charged with an output voltage from the electric power management device; and
a controller configured to control the rectifier, the electric power management device, and the charger,
wherein the controller includes a first control module and a second control module, and includes the electronic circuit as a third control module,
wherein the first control module controls transmission and reception of signals between the controller and an external device,
wherein the second control module detects a predetermined voltage value in the receiver and stores the detected voltage value in a temporary storage area, and
wherein the electronic circuit determines a power receiving state of the receiver based on the voltage value stored in the temporary storage area.

11. The electronic circuit according to claim 10,
wherein the receiver receives microwaves having a frequency of 0.9 GHz or higher,
wherein the second control module detects the predetermined voltage value in the receiver at a plurality of timings, and
wherein the electronic circuit determines the power receiving state of the receiver based on the voltage values detected at the plurality of timings.

12. The electronic circuit according to claim 11,
wherein the electronic circuit includes:
a gradient calculation device configured to calculate, from the voltage values detected at the plurality of timings and acquired from the temporary storage area, a gradient value representing a difference per unit time of the voltage value; and
a gradient comparison device configured to compare the calculated gradient value with a predetermined threshold value.

13. A method for determining a power receiving state, the method being executed by a receiver configured to receive microwave power wirelessly,
the receiver comprising:
a rectifier for rectifying transmitting power;
an electric power management device for managing a rectified voltage from the rectifier;
a charger to be electrically charged with an output voltage from the electric power management device; and
a controller configured to control the rectifier, the electric power management device, and the charger,
wherein the controller executes a first control step, a second control step, and a third control step,
wherein, in the first control step, the controller controls transmission and reception of signals between the controller and an external device,
wherein, in the second control step, the controller detects a predetermined voltage value in the receiver and stores the detected voltage value in a temporary storage area, and
wherein, in the third control step, the controller determines the power receiving state of the receiver based on the voltage value stored in the temporary storage area.

14. The method for determining a power receiving state according to claim 13,
wherein the receiver receives microwaves having a frequency of 0.9 GHz or higher,
wherein, in the second control step, the controller detects the predetermined voltage value in the receiver at a plurality of timings, and
wherein, in the third control step, the controller determines the power receiving state of the receiver based on the voltage values detected at the plurality of timings.

15. The method for determining a power receiving state according to claim 14,
wherein, in the third control step, the controller executes:
a gradient calculation step configured to calculate, from the voltage values detected at the plurality of timings and acquired from the temporary storage area, a gradient value representing a difference per unit time of the voltage value; and
a gradient comparison step configured to compare the calculated gradient value with a predetermined threshold value.
